(19) United States
(12) Patent Application Publication
(10) Pub. No.: US 2023/0202221 A1
(43) Pub. Date: Jun. 29, 2023

(54) THERMAL TRANSFER SHEET, DISCOLORED OR DECOLORIZED PRINTED MATERIAL, AND METHOD FOR PRODUCING DISCOLORED OR DECOLORIZED PRINTED MATERIAL

(71) Applicant: Dai Nippon Printing Co., Ltd., Tokyo (JP)

(72) Inventors: Ryoji HATTORI, Tokyo (JP); Yuki IWASAKI, Tokyo (JP)

(73) Assignee: Dai Nippon Printing Co., Ltd., Tokyo (JP)

(21) Appl. No.: 18/000,150

(22) PCT Filed: Jun. 10, 2021
(86) PCT No.: PCT/JP2021/022069

§ 371 Date: Nov. 29, 2022

(30) Foreign Application Priority Data
Jun. 12, 2020 (JP) 2020-102720

(51) Int. Cl. B41M 5/382; B41M 5/385

(52) U.S. Cl. CPC B41M 5/38292; B41M 5/385; B41M 5/38235

(57) ABSTRACT

A thermal transfer sheet according to an embodiment of the present disclosure includes a substrate and a transfer layer disposed on one surface side of the substrate, in which the transfer layer includes at least a discoloration- or decolorization-imparting layer, and the discoloration- or decolorization-imparting layer contains a compound responsible for discoloration or decolorization.

### TECHNICAL FIELD

The present disclosure relates to a thermal transfer sheet, a combination of a thermal transfer sheet and an intermediate transfer medium, a thermal transfer printed material, a method for producing a thermal transfer printed material, a discolored or decolorized printed material, and a method for producing a discolored or decolorized printed material.

### BACKGROUND ART

Various thermal transfer methods have been employed as methods for producing printed materials. For example, a method for forming a thermal transfer image on a transfer-receiving article by using a thermofusible transfer method or a sublimation thermal transfer method is known.

In conventional printed materials, various efforts have been made to ensure that images formed on transfer-receiving articles do not change. However, in recent years, as the applications of printed materials have expanded, there has been a demand for printed materials having various functions and characteristics.

### SUMMARY OF INVENTION

### Technical Problem

It is an object of the present disclosure to provide a thermal transfer sheet and a combination of the thermal transfer sheet and an intermediate transfer medium, the sheet and the combination being capable of producing a thermal transfer printed material that can discolor or decolorize an image.

It is another object of the present disclosure to provide a thermal transfer printed material capable of discoloring or decolorizing an image, and a method for producing the thermal transfer printed material.

It is another object of the present disclosure to provide a discolored or decolorized printed material in which an image is discolored or decolorized, and a method for producing the discolored or decolorized printed material. Solution to Problem

According to the present disclosure, a thermal transfer sheet includes a substrate and a transfer layer disposed on one surface side of the substrate,
in which the transfer layer includes at least a discoloration- or decolorization-imparting layer, and
the discoloration- or decolorization-imparting layer contains a compound responsible for discoloration or decolorization.

According to the present disclosure, a thermal transfer printed material includes a transfer-receiving article, a general image, and a discoloration- or decolorization-imparting image,

in which the discoloration- or decolorization-imparting image is in contact with at least part of the general image and contains a compound responsible for discoloration or decolorization.

According to the present disclosure, a method for producing the thermal transfer printed material described above includes the steps of:
providing the thermal transfer sheet described above and a transfer-receiving article; and
forming a general image and a discoloration- or decolorization-imparting image on the transfer-receiving article in such a manner that the general image and the discoloration- or decolorization-imparting image are in contact with each other,
in which the discoloration- or decolorization-imparting image is formed from the discoloration- or decolorization-imparting layer of the thermal transfer sheet.

According to the present disclosure, a discolored or decolorized printed material includes a transfer article and a discolored or decolorized portion,

in which the discolored or decolorized portion contains a reaction product of a coloring material and a compound responsible for discoloration or decolorization.

According to the present disclosure, a method for producing the discolored or decolorized printed material described above includes:
a step of providing the thermal transfer printed material described above; and
a light irradiation step of performing irradiation with a light beam having a predetermined intensity for a predetermined period of time from a side of the thermal transfer printed material adjacent to the general image and the discoloration- or decolorization-imparting image to discolor or decolorize the general image.

According to the present disclosure, a method for producing the discolored or decolorized printed material described above includes:
a step of providing the thermal transfer printed material described above; and
a heat treatment step of holding the general image and the discoloration- or decolorization-imparting image of the thermal transfer printed material at a predetermined temperature for a predetermined period of time to discolor or decolorize the general image.

According to the present disclosure, provided is a combination of the thermal transfer sheet described above and an intermediate transfer medium,
in which the intermediate transfer medium includes at least a substrate and a retransfer layer, and
the retransfer layer includes at least a receiving layer.

According to the present disclosure, a thermal transfer printed material includes a transfer-receiving article and a retransfer layer,
in which the retransfer layer includes at least a receiving layer, a general image, and a discoloration- or decolorization-imparting image, and
the discoloration- or decolorization-imparting image is in contact with at least part of the general image and contains a compound responsible for discoloration or decolorization.

According to the present disclosure, a method for producing the thermal transfer printed material described above includes the steps of:
providing the combination of the thermal transfer sheet and the intermediate transfer medium described above and the transfer-receiving article;
forming the general image and the discoloration- or decolorization-imparting image on the receiving layer of the intermediate transfer medium in such a manner that the general image and the discoloration- or decolorization-imparting image are in contact with each other; and
transferring the retransfer layer including at least the receiving layer, the general image, and the discoloration- or decolorization-imparting image onto the transfer-receiving article,
in which the discoloration- or decolorization-imparting image is formed from the discoloration- or decolorization-imparting layer of the thermal transfer sheet.

According to the present disclosure, a discolored or decolorized printed material includes a transfer-receiving article and a discolored or decolorized retransfer layer,
in which the discolored or decolorized retransfer layer includes at least a receiving layer and a discolored or decolorized portion, and
the discolored or decolorized portion contains a reaction product of a coloring material and a compound responsible for discoloration or decolorization.

According to the present disclosure, a method for producing the discolored or decolorized printed material described above includes:
a step of providing the thermal transfer printed material described above; and
a light irradiation step of irradiating the thermal transfer printed material with a light beam having a predetermined intensity from a side of the thermal transfer printed material adjacent to the retransfer layer for a predetermined period of time to discolor or decolorize the general image.

According to the present disclosure, a method for producing the discolored or decolorized printed material described above includes:
a step of providing the thermal transfer printed material described above; and
a heat treatment step of holding the retransfer layer of the thermal transfer printed material at a predetermined temperature for a predetermined period of time to discolor or decolorize the general image. Advantageous Effects of Invention

According to the present disclosure, it is possible to provide the thermal transfer sheet and the combination of the thermal transfer sheet and an intermediate transfer medium, the sheet and the combination being capable of producing a thermal transfer printed material that can discolor or decolorize an image.

According to the present disclosure, it is possible to provide the thermal transfer printed material capable of discoloring or decolorizing an image, and a method for producing the thermal transfer printed material.

According to the present disclosure, it is possible to provide the discolored or decolorized printed material in which an image is discolored or decolorized, and a method for producing the discolored or decolorized printed material.

### BRIEF DESCRIPTION OF DRAWINGS

FIG. 1 is a schematic cross-sectional view illustrating an embodiment of a thermal transfer sheet of the present disclosure.

FIG. 2 is a schematic cross-sectional view illustrating an embodiment of a thermal transfer sheet of the present disclosure.

FIG. 3 is a schematic cross-sectional view illustrating an embodiment of a thermal transfer sheet of the present disclosure.

FIG. 4 is a schematic cross-sectional view illustrating an embodiment of a thermal transfer sheet of the present disclosure.

FIG. 5 is a schematic cross-sectional view illustrating an embodiment of a thermal transfer sheet of the present disclosure.

FIG. 6 is a schematic cross-sectional view illustrating an embodiment of a thermal transfer sheet of the present disclosure.

FIG. 7 is a schematic cross-sectional view illustrating an embodiment of a thermal transfer sheet of the present disclosure.

FIG. 8 is a schematic cross-sectional view illustrating an embodiment of a thermal transfer sheet of the present disclosure.

FIG. 9 is a schematic cross-sectional view illustrating an embodiment of a thermal transfer sheet of the present disclosure.

FIG. 10 is a schematic cross-sectional view illustrating an embodiment of a combination of a thermal transfer sheet and an intermediate transfer medium according to the present disclosure.

FIG. 11 is a schematic cross-sectional view illustrating an embodiment of a thermal transfer printed material of a first form.

FIG. 12 is a schematic cross-sectional view illustrating an embodiment of a thermal transfer printed material of a first form.

FIG. 13 is a schematic cross-sectional view illustrating an embodiment of a thermal transfer printed material of a first form.

FIG. 14 is a schematic cross-sectional view illustrating an embodiment of a thermal transfer printed material of a first form.

FIG. 15 is a schematic cross-sectional view illustrating an embodiment of a discolored or decolorized printed material of a first form.

FIG. 16 is a schematic cross-sectional view illustrating an embodiment of a discolored or decolorized printed material of a first form.

FIG. 17 is a schematic view partially illustrating an embodiment of a method for producing a discolored or decolorized printed material of a first form.

FIG. 18 is a schematic cross-sectional view illustrating an embodiment of a thermal transfer printed material of a second form.

FIG. 19 is a schematic cross-sectional view illustrating an embodiment of a thermal transfer printed material of a second form.

FIG. 20 is a schematic cross-sectional view illustrating an embodiment of a thermal transfer printed material of a second form.

FIG. 21 is a schematic cross-sectional view illustrating an embodiment of a thermal transfer printed material of a second form.

FIG. 22 is a schematic cross-sectional view illustrating an embodiment of a discolored or decolorized printed material of a second form.

FIG. 23 is a schematic cross-sectional view illustrating an embodiment of a discolored or decolorized printed material of a second form.

FIG. 24 is a schematic view partially illustrating an embodiment of a method for producing a discolored or decolorized printed material of a second form.

### DESCRIPTION OF EMBODIMENTS

### Thermal Transfer Sheet

According to the present disclosure, a thermal transfer sheet includes a substrate and a transfer layer disposed on one surface of the substrate, in which the transfer layer includes at least a discoloration- or decolorization-imparting layer. This makes it possible to provide a thermal transfer printed material that can discolor or decolorize a general image.

The thermal transfer sheet of the present disclosure will be described below with reference to the drawings.

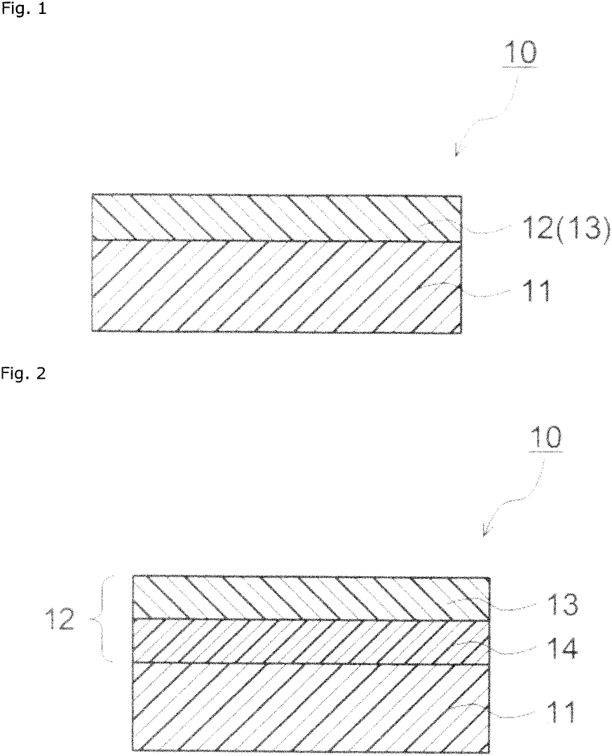

In an embodiment, as illustrated in FIG. 1, a thermal transfer sheet 10 includes a substrate 11 and a transfer layer 12 disposed on one surface of the substrate 11. The transfer layer 12 includes a discoloration- or decolorization-imparting layer 13.

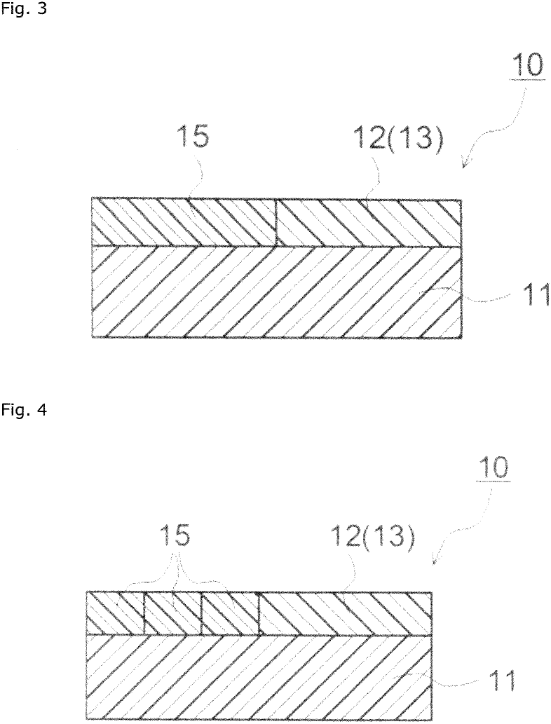

In an embodiment, as illustrated in FIG. 2, the thermal transfer sheet 10 includes the substrate 11 and the transfer layer 12 disposed on one surface of the substrate 11. The transfer layer 12 includes the discoloration- or decolorization-imparting layer 13 and a peeling layer 14. As illustrated in FIG. 2, the peeling layer 14 is disposed between the substrate 11 and the discoloration- or decolorization-imparting layer 13.

In an embodiment, as illustrated in FIG. 3, the thermal transfer sheet 10 includes the substrate 11, a coloring material layer 15, and the transfer layer 12, which are disposed on one surface of the substrate 11. The transfer layer 12 includes the discoloration- or decolorization-imparting layer 13. As illustrated in FIG. 3, the coloring material layer 15 and the transfer layer 12 are disposed as being frame sequentially on the same surface.

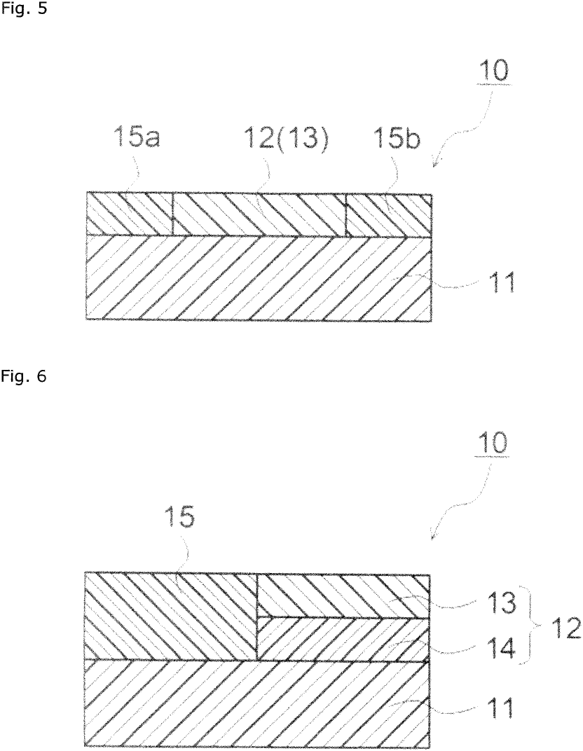

In an embodiment, as illustrated in FIG. 4, the thermal transfer sheet 10 includes the substrate 11, the coloring material layer 15, and the transfer layer 12, which are disposed on one surface of the substrate 11. The transfer layer 12 includes the discoloration- or decolorization-imparting layer 13. As illustrated in FIG. 4, the coloring material layer 15 and the transfer layer 12 are disposed as being frame sequentially on the same surface. As illustrated in FIG. 4, with regard to the coloring material layer 15, multiple coloring material layers 15 are disposed as being frame sequentially on the same surface.

In an embodiment, as illustrated in FIG. 5, the thermal transfer sheet 10 includes the substrate 11, a coloring material layer 15a, the transfer layer 12, and a coloring material layer 15b, which are disposed on one surface of the substrate 11. The transfer layer 12 includes the discoloration- or decolorization-imparting layer 13. As illustrated in FIG. 5, the coloring material layer 15a, the coloring material layer 15b, and the transfer layer 12 are disposed as being frame sequentially on the same surface. With regard to the coloring material layer 15a and/or the coloring material layer 15b, multiple coloring material layers 15 may be disposed as being frame sequentially on the same surface (not illustrated).

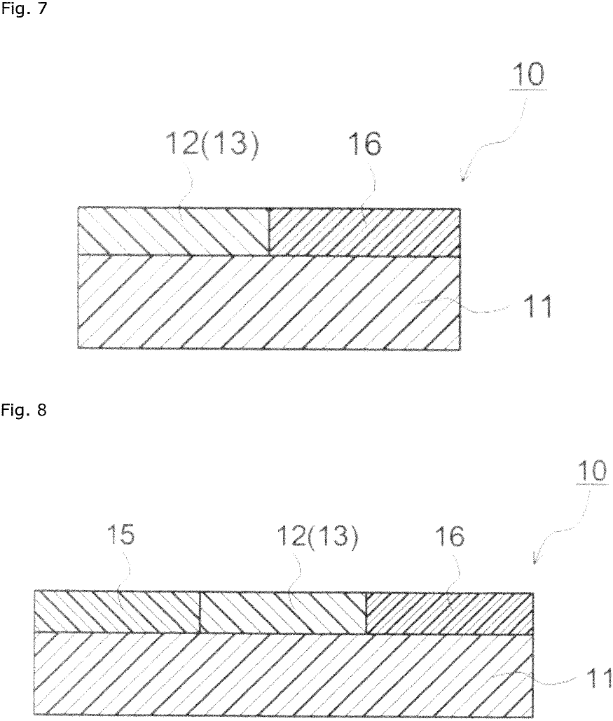

In an embodiment, as illustrated in FIG. 6, the thermal transfer sheet 10 includes the substrate 11, the coloring material layer 15, and the transfer layer 12, which are disposed on one surface of the substrate 11. The transfer layer 12 includes the discoloration- or decolorization-imparting layer 13 and the peeling layer 14. As illustrated in FIG. 6, the peeling layer 14 is disposed between the substrate 11 and the discoloration- or decolorization-imparting layer 13. As illustrated in FIG. 6, the coloring material layer 15 and the transfer layer 12 are disposed as being frame sequentially on the same surface. The peeling layer 14 may be disposed between the substrate 11 and the coloring material layer 15 (not illustrated). With regard to the coloring material layer 15, multiple coloring material layers 15 may be disposed as being frame sequentially on the same surface (not illustrated).

In an embodiment, as illustrated in FIG. 7, the thermal transfer sheet 10 includes the substrate 11, the transfer layer 12, and a protective layer 16, which are disposed on one surface of the substrate 11. The transfer layer 12 includes the discoloration- or decolorization-imparting layer 13. As illustrated in FIG. 7, the protective layer 16 and the transfer layer 12 are disposed as being frame sequentially on the same surface. The thermal transfer sheet 10 may include the peeling layer 14 between the substrate 11 and the discoloration- or decolorization-imparting layer 13 and/or the protective layer 16 (not illustrated).

In an embodiment, as illustrated in FIG. 8, the thermal transfer sheet 10 includes the substrate 11, the coloring material layer 15, the transfer layer 12, and the protective layer 16, which are disposed on one surface of the substrate 11. The transfer layer 12 includes the discoloration- or decolorization-imparting layer 13. As illustrated in FIG. 8, the coloring material layer 15, the transfer layer 12, and the protective layer 16 are disposed as being frame sequentially on the same surface. The coloring material layer 15, the transfer layer 12, and the protective layer 16 may be disposed in the order of the coloring material layer 15, the transfer layer 12, and the protective layer 16 (FIG. 8), or may be disposed in the order of the transfer layer 12, the coloring material layer 15, and the protective layer 16 (not illustrated). The thermal transfer sheet 10 may include the peeling layer 14 between the substrate 11 and at least one layer selected from the discoloration- or decolorization-imparting layer 13, the coloring material layer 15, and the protective layer 16 (not illustrated). With regard to the coloring material layer 15, multiple coloring material layers 15 may be disposed as being frame sequentially on the same surface (not illustrated).

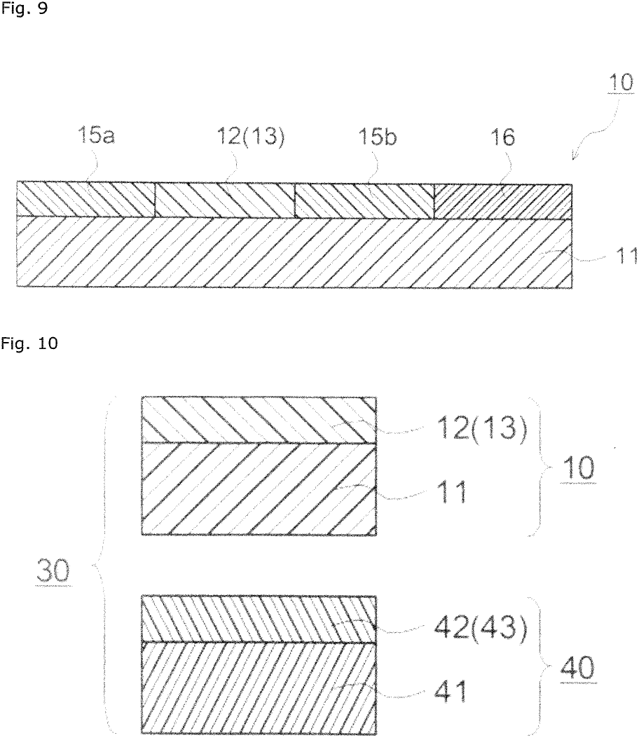

In an embodiment, as illustrated in FIG. 9, the thermal transfer sheet 10 includes the substrate 11, the coloring material layer 15a, the transfer layer 12, the coloring material layer 15b, and the protective layer 16, which are disposed on one surface of the substrate 11. The transfer layer 12 includes the discoloration- or decolorization-imparting layer 13. As illustrated in FIG. 8, the coloring material layer 15a, the transfer layer 12, the coloring material layer 15b, and the protective layer 16 are disposed as being frame sequentially on the same surface. The thermal transfer sheet 10 may include the peeling layer 14 between the substrate 11 and at least one layer selected from the discoloration- or decolorization-imparting layer 13, the coloring material layer 15a, the coloring material layer 15b, and the protective layer 16 (not illustrated). With regard to the coloring material layer 15a and/or the coloring material layer 15b, multiple coloring material layers 15a and multiple coloring material layers 15b may be disposed as being frame sequentially on the same surface (not illustrated).

The thermal transfer sheet 10 may include a primer layer between the substrate 11 and the coloring material layer 15 and/or the discoloration- or decolorization-imparting layer 13 (not illustrated).

The thermal transfer sheet 10 may include a release layer between the substrate 11 and at least one layer selected from the discoloration- or decolorization-imparting layer 13, the peeling layer 14, the coloring material layer 15, and the protective layer 16 (not illustrated).

The thermal transfer sheet 10 may include a back layer (not illustrated) disposed on a side of the substrate 11 opposite to the side on which the transfer layer 12 is disposed.

The discoloration- or decolorization-imparting layer 13 may be disposed on the entire surface or part of the protective layer 16.

The above-described layer configurations of the thermal transfer sheet 10 can be combined as appropriate.

In the thermal transfer sheet according to an embodiment,
a hue difference ΔE*ab is 5 or more between
the hue of a portion having a reflection density of 1.5 ± 0.1, the hue being measured from the side of a sublimation black image that has been formed on one surface side of a transfer-receiving article, and
the hue of a portion corresponding to the portion having a reflection density of 1.5 ± 0.1, the hue being measured, after irradiation using a xenon lamp at an irradiation intensity of 1.2 W/m² for 24 hours from the side of the sublimation black image that has been formed on the one surface side of the transfer-receiving article and the discoloration- or decolorization-imparting image that has been formed on the sublimation black image from the discoloration- or decolorization-imparting layer, from the side of the sublimation black image and the discoloration- or decolorization-imparting image.

The hue difference ΔE*ab is preferably 10 or more.

In the present invention, the reflection density has an error of ±0.1.

In the thermal transfer sheet according to an embodiment,
a hue difference ΔE*ab is 5 or more between
the hue of a portion having a reflection density of 1.5 ± 0.1, the hue being measured from the side of a sublimation black image that has been formed on one surface side of a transfer-receiving article, and
the hue of a portion corresponding to the portion having a reflection density of 1.5 ± 0.1, the hue being measured, after the sublimation black image that has been formed on the one surface side of the transfer-receiving article and a discoloration- or decolorization-imparting image that has been formed on the sublimation black image from the discoloration- or decolorization-imparting layer are held at a temperature of 50° C. for 72 hours, from the side of the sublimation black image and the discoloration- or decolorization-imparting image.

The hue difference ΔE*ab is preferably 10 or more.

In the above-described embodiment, examples of the transfer-receiving article include paper substrates, such as woodfree paper, art paper, coated paper, resin-coated paper, cast coated paper, paperboard, synthetic paper, and impregnated paper, resin films described below, laminates thereof, and cards.

Each of the layers that can be included in the thermal transfer sheet of the present disclosure will be described below.

### Substrate

The substrate of the thermal transfer sheet has heat resistance to thermal energy applied during thermal transfer, mechanical strength that can support each layer disposed on the substrate, and solvent resistance.

As the substrate of the thermal transfer sheet, a film composed of a resin material (hereinafter, simply referred to as a “resin film”) can be used. Examples of the resin material include polyesters, such as poly(ethylene terephthalate) (PET), poly(butylene terephthalate) (PBT), poly(ethylene naphthalate) (PEN), 1,4-poly(cyclohexylenedimethylene terephthalate), terephthalic acid-cyclohexanedimethanol-ethylene glycol copolymers; polyamides, such as nylon 6 and nylon 6,6; polyolefins, such as polyethylene (PE), polypropylene (PP), and polymethylpentene; vinyl resins, such as poly(vinyl chloride), poly(vinyl alcohol) (PVA), poly(vinyl acetate), vinyl chloride-vinyl acetate copolymers, poly(vinyl butyral), and poly(vinyl pyrrolidone) (PVP); (meth)acrylic resins, such as polyacrylate, polymethacrylate, and poly(methyl methacrylate); imide resins, such as polyimide and poly(ether imide); cellulose resins, such as cellophane, cellulose acetate, nitrocellulose, cellulose acetate propionate (CAP), and cellulose acetate butylate (CAB); styrene resins, such as polystyrene (PS); polycarbonate; and ionomer resins.

Among the above resins, polyesters, such as PET and PEN, are preferred, and PET is particularly preferred, from the viewpoints of heat resistance and mechanical strength.

In the present disclosure, the term “(meth)acrylic” includes both “acrylic” and “methacrylic”. The term “(meth)acrylate” includes both “acrylate” and “methacrylate”.

A laminate including the above-described resin film can also be used as the substrate. The laminate of the resin film can be produced by the use of, for example, a dry lamination method, a wet lamination method, or an extrusion method.

When the substrate of the thermal transfer sheet is a resin film, the resin film may be a stretched film or an unstretched film. The resin film is preferably uniaxially or biaxially stretched film from the viewpoint of strength.

The substrate of the thermal transfer sheet preferably has a thickness of 2 µm or more and 25 µm or less, more preferably 3 µm or more and 16 µm or less. This can result in good mechanical strength of the substrate and good thermal energy transfer during the thermal transfer.

### Transfer Layer

The transfer layer of the thermal transfer sheet is disposed on one surface side of the substrate and is a layer including at least the discoloration- or decolorization-imparting layer.

The transfer layer of the thermal transfer sheet may include a peeling layer between the substrate and the discoloration- or decolorization-imparting layer.

### Discoloration- or Decolorization-Imparting Layer

The discoloration- or decolorization-imparting layer is a layer containing a compound responsible for discoloration or decolorization. The compound responsible for discoloration or decolorization is a compound having the function of discoloring or decolorizing an image. Examples of the mechanism of discoloring or decolorizing an image include a reaction of the compound responsible for discoloration or decolorization and a component, such as a coloring material, contained in the image; and the initiation of a reaction of the component in the image. Examples of the reaction include decomposition, breakdown, and polymerization of the component. The discoloration- or decolorization-imparting layer contains the compound responsible for discoloration or decolorization and thus can discolor or decolorize the image of the thermal transfer printed material.

The discoloration- or decolorization-imparting layer may be a sublimation transfer discoloration- or decolorization-imparting layer, in which a sublimable compound responsible for discoloration or decolorization is to be transferred, or may be a fusion transfer discoloration- or decolorization-imparting layer, in which the discoloration- or decolorization-imparting layer itself is to be transferred.

The compound responsible for discoloration or decolorization is preferably a compound that reacts with or initiates a reaction with an image component by light irradiation and/or heat treatment.

In an embodiment, the compound responsible for discoloration or decolorization is at least one compound selected from acid-generating materials, chelating materials, and thermoplastic materials.

As an acid-generating material, for example, a compound used for a chemically amplified photoresist or cationic polymerization is used (see “Imejingu yo Yukizairyou” (Organic Materials for Imaging) edited by The Japanese Research Association for Organic Electronics Materials, Bunshin Publishing Co. (1993), pp. 187-192). Examples of compounds suitable for the present disclosure are listed below.

First, salts of aromatic onium compounds, such as diazonium, ammonium, iodonium, sulfonium, and phosphonium, and B(C₆F₅)₄—, PF₆—, AsF₆—, SbF₆—, and CF₃SO₃— are exemplified.

Specific examples of onium compounds that can be used in the present disclosure are illustrated below.

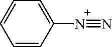

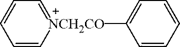

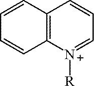

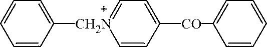

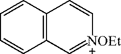

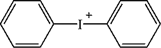 [SMILES: c1ccc([I+]c2ccccc2)cc1]

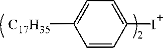

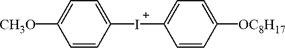

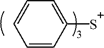

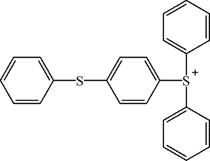 [SMILES: c1ccc(Sc2ccc([S+](c3ccccc3)c3ccccc3)cc2)cc1]

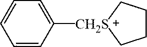

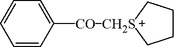

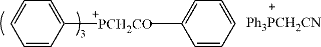

Second, sulfonated products that generate sulfonic acid can be exemplified, and specific examples of compounds thereof are illustrated below.

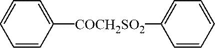

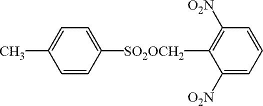

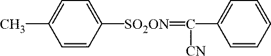

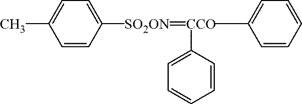

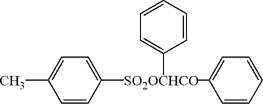

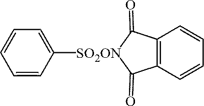

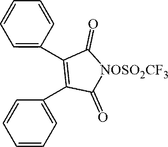

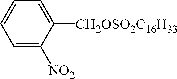

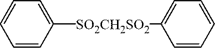

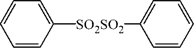

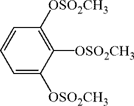

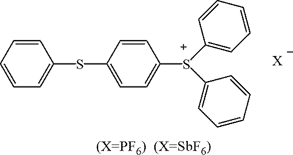

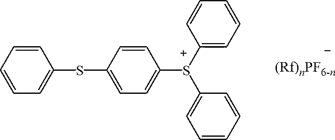 [SMILES: c1ccc(Sc2ccc([S+](c3ccccc3)c3ccccc3)cc2)cc1 ; "(Rf)nPF6-n"]

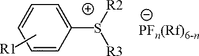

Third, halides that photogenerate hydrogen halides can also be used, and those having a triazine structure are preferred. The specific compounds are exemplified below.

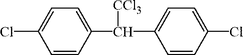

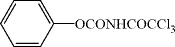

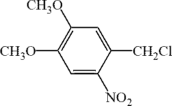

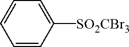

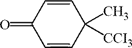

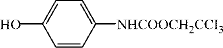

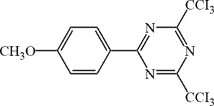

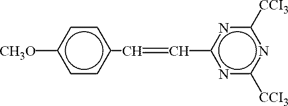

Fourth, iron-arene complexes can be exemplified.

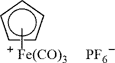

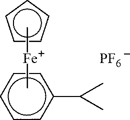

Chelating materials are complexes containing metal ions. Examples of the metal ions include divalent and polyvalent metals belonging to groups I to VIII of the periodic table. Among them, for example, Al, Co, Cr, Cu, Fe, Mg, Mn, Mo, Ni, Sn, Ti, and Zn are preferred. In particular, for example, Ni, Cu, Co, Cr, and Zn are preferred. As the chelating material, a complex that contains Ni²⁺, Cu²⁺, Co²⁺, Cr²⁺, or Zn²⁺ and that is represented by the following general formula is preferably used.

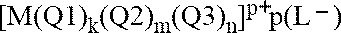

where in the formula, M is a metal ion, and Q1, Q2, and Q3 are each a coordination compound that can form a coordinate bond with the metal ion represented by M. Examples of the coordination compound can be selected from coordination compounds described in “Kireto Kagaku (Chelate Chemistry) (5)” (Nankodo Co., Ltd). Particularly preferably, a coordination compound containing at least one amino group that can be coordinated with the metal can be exemplified. Specific examples include ethylenediamine and derivatives thereof, glycinamide and derivatives thereof, and picolinamide and derivatives thereof.

L is a counter anion that can form a complex. Examples thereof include inorganic compound anions, such as CrO₄²⁻, SO₄²⁻, and ClO₄⁻, and organic compound anions, such as benzenesulfonic acid derivatives and alkylsulfonic acid derivatives. Particularly preferred are tetraphenylborate anions and derivatives thereof and alkylbenzenesulfonate anions and derivatives thereof. k is an integer of 1, 2, or 3, m is 1, 2, or 0, and n is 1 or 0. These are determined by whether the complex represented by the foregoing general formula is tetradentate or hexadentate, or by the number of ligands Q1, Q2, and Q3. p is 1, 2, or 3.

Examples of such a chelating material can include those exemplified in U.S. Pat. No. 4,987,049. A particularly preferred structure of the chelating material is exemplified below.

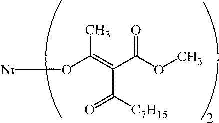

Examples of the thermoplastic material include phthalates, such as dimethyl phthalate, dibutyl phthalate, dioctyl phthalate, and didecyl phthalate, trimellitates, such as octyl trimellitate, isononyl trimellitate, and isodesol trimellitate, pyromellitates, such as octyl pyromellitate, adipates, such as diocryl adipate, methyl lauryl adipate, di-2-ethylhexyl adipate, and ethyl lauryl adipate, other oleates, succinates, maleates, sebacates, citrates, epoxidized soybean oil, epoxidized linseed oil, epoxystearic acid epoxides, ortho-phosphates, such as triphenyl phosphate and tricresyl phosphate, phosphites, such as triphenyl phosphite, tris(tridecyl) phosphite, and dibutyl hydrogen phosphite, and glycolates, such as ethyl phthalyl ethyl glycote and butyl phthalyl butyl glycols.

The “light irradiation” refers to, for example, irradiation using a xenon lamp at an irradiation intensity of 1.2 W/m² for 24 hours. Other than irradiation using the xenon lamp, for example, irradiation with sunlight, irradiation using a fluorescent lamp, an LED lamp, and so forth are exemplified.

The “heat treatment” refers to holding the temperature at 10° C. or higher and 100° C. or lower, and the time is not particularly limited. The “heat treatment” is, for example, holding the temperature at 50° C. for 72 hours.

In the discoloration- or decolorization-imparting layer, the solid content of the compound responsible for discoloration or decolorization is preferably 0.1% or more by mass and 80% or less by mass, more preferably 1% or more by mass and 70% or less by mass, even more preferably 5% or more by mass and 60% or less by mass, based on the total component contained in the discoloration- or decolorization-imparting layer. This can further improve discoloration or decolorization properties in the thermal transfer printed material.

In the case of a fusion transfer discoloration- or decolorization-imparting layer, the solid content of the compound responsible for discoloration or decolorization in the discoloration- or decolorization-imparting layer is preferably 0.1% or more by mass and 60% or less by mass, more preferably 3% or more by mass and 50% or less by mass, even more preferably 5% or more by mass and 30% or less by mass.

In the case of a sublimation transfer discoloration- or decolorization-imparting layer, the solid content of the compound responsible for discoloration or decolorization in the discoloration- or decolorization-imparting layer is preferably 5% or more by mass and 80% or less by mass, more preferably 7% or more by mass and 70% or less by mass, even more preferably 10% or more by mass and 60% or less by mass, based on the total component contained in the discoloration- or decolorization-imparting layer.

The discoloration- or decolorization-imparting layer may contain at least one binder. Examples of the binder contained in the discoloration- or decolorization-imparting layer include polyolefins, vinyl resins, (meth)acrylic resins, cellulose resins, polyesters, epoxy resins, polyamides, polycarbonates, styrene resins, polyurethanes, ionomer resins, and acetal resins.

The discoloration- or decolorization-imparting layer preferably has a resin material content of 10% or more by mass and 99.9% or less by mass, more preferably 20% or more by mass and 99% or less by mass, even more preferably 30% or more by mass and 98% or less by mass, based on the total component contained in the discoloration- or decolorization-imparting layer. This can further improve discoloration or decolorization properties in the thermal transfer printed material.

The discoloration- or decolorization-imparting layer may contain an additive. Examples of the additive include fillers, plasticizers, antistatic agents, ultraviolet absorbers, inorganic particles, release materials, and dispersants.

The discoloration- or decolorization-imparting layer preferably has a thickness of 0.2 µm or more and 10 µm or less, more preferably 0.3 µm or more and 5 µm or less. This can further improve discoloration or decolorization properties in the thermal transfer printed material.

The discoloration- or decolorization-imparting layer can be formed by dispersing or dissolving the above-described materials in an appropriate solvent to prepare a coating liquid, applying the coating liquid onto, for example, the substrate, the peeling layer, the release layer, or the primer layer to form a coating film, and drying the coating film. As the application means, known means, such as a roll coating method, a reverse roll coating method, a gravure coating method, a reverse gravure coating method, a bar coating method, or a rod coating method, can be used.

### Peeling Layer

The peeling layer of the thermal transfer sheet is a layer to be transferred from the thermal transfer sheet onto the intermediate transfer medium or the thermal transfer printed material. The thermal transfer sheet including the peeling layer can improve the transferability of the fusion transfer coloring material layer and the moisture-retentive layer, which are disposed on the peeling layer.

The peeling layer of the thermal transfer sheet may contain at least one resin material. Examples of the resin material contained in the peeling layer include polyesters, polyamides, polyolefins, vinyl resins, (meth)acrylic resins, imide resins, cellulose resins, styrene resins, polycarbonates, and ionomer resins. The peeling layer preferably contains a (meth)acrylic resin, more preferably a poly(methyl methacrylate), from the viewpoint of transferability.

The peeling layer of thermal transfer sheet may contain the following release material and the foregoing additive.

The peeling layer of the thermal transfer sheet has a thickness of, for example, 0.1 µm or more and 3 µm or less.

The peeling layer of the thermal transfer sheet can be formed by dispersing or dissolving the above-described material in an appropriate solvent to prepare a coating liquid, applying the coating liquid onto, for example, the substrate or the release layer by the above-described application means to form a coating film, and drying the coating film.

### Coloring Material Layer

The coloring material layer is a layer used to form a general image. The coloring material layer may be a sublimation transfer coloring material layer, in which a sublimation dye contained in the coloring material layer is to be transferred, or may be a fusion transfer coloring material layer, in which the coloring material layer itself is to be transferred. The thermal transfer sheet of the present disclosure may include both the sublimation transfer coloring material layer and the fusion transfer coloring material layer.

The coloring material layer contains at least one coloring material. The coloring material contained in the coloring material layer may be a pigment or a dye. The dye may be a sublimation dye.

Examples of the pigment include carbon black, acetylene black, lamp black, black smoke, iron black, aniline black, silica, calcium carbonate, titanium oxide, cadmium red, cadmopone red, chromium red, vermilion, colcothar, azo-based pigments, alizarin lake, quinacridone, cochineal lake perylene, yellow ocher, aureolin, cadmium yellow, cadmium orange, chromium yellow, zinc yellow, naples yellow, nickel yellow, azo-based pigments, greenish yellow, ultramarine, blue verditer, cobalt, phthalocyanine, anthraquinone, indigoid, cinnabar green, cadmium green, chromium green, phthalocyanine, azomethine, perylene, and aluminum pigments.

Examples of the dye include diarylmethane dyes, triarylmethane dyes, thiazole dyes, merocyanine dyes, pyrazolone dyes, methine dyes, indoaniline dyes, acetophenone azomethine dyes, pyrazolo azomethine dyes, xanthene dyes, oxazine dyes, thiazine dyes, azine dyes, acridine dyes, azo dyes, spiropyran dyes, indolinospiropyran dyes, fluoran dyes, naphthoquinone dyes, anthraquinone dyes, and quinophthalone dyes.

The coloring material layer may contain at least one resin material. Examples of the resin material contained in the coloring material layer include polyesters, polyamides, polyolefins, vinyl resins, (meth)acrylic resins, cellulose resins, styrene resins, polycarbonates, phenoxy resins, ionomer resins, and acetal resins.

The coloring material layer may contain the above-described additive.

The coloring material layer has a thickness of, for example, 0.1 µm or more and 3 µm or less.

The coloring material layer can be formed by dispersing or dissolving the above-described material in an appropriate solvent to prepare a coating liquid, applying the coating liquid onto, for example, the substrate, the peeling layer, the primer layer, or the release layer by the above-described application means to form a coating film, and drying the coating film.

### Protective Layer

The protective layer of the thermal transfer sheet is a layer to be transferred from the thermal transfer sheet onto an intermediate transfer medium or onto the thermal transfer printed material. The thermal transfer sheet including the protective layer can protect the image of the thermal transfer printed material.

The protective layer of the thermal transfer sheet may contain at least one resin material. Examples of the resin material contained in the protective layer include (meth)acrylic resins, polyesters, cellulose resins, styrene resins, polyamides, vinyl resins, polycarbonates, silicone resins, hydroxy group-containing resins, thermosetting resins, and actinic radiation-curable resins.

The protective layer of the thermal transfer sheet has a resin material content of, for example, 50% or more by mass and 90% or less by mass.

The protective layer of the thermal transfer sheet may contain the above-described additive.

The protective layer of the thermal transfer sheet has a thickness of, for example, 0.5 µm or more and 10 µm or less.

The protective layer of the thermal transfer sheet can be formed by dispersing or dissolving the above-described material in an appropriate solvent to prepare a coating liquid, applying the coating liquid onto, for example, the substrate, the peeling layer, or the release layer by the above-described application means to form a coating film, and drying the coating film.

### Primer Layer

The primer layer is a layer that remains on the substrate during thermal transfer of the thermal transfer sheet. The thermal transfer sheet including the primer layer can improve the adhesion between freely-selected layers.

When the coloring material layer and the discoloration- or decolorization-imparting layer are sublimation transfer layers, the thermal transfer sheet preferably includes the primer layer between the substrate and the coloring material layer and between the substrate and the discoloration- or decolorization-imparting layer.

The primer layer may contain at least one resin material. Examples of the resin material contained in the primer layer include polyesters, vinyl resins, polyurethanes, (meth)acrylic resins, polyamides, polyethers, styrene resins, and cellulose resins.

The primer layer may contain the above-described additive.

The primer layer has a thickness of, for example, 0.05 µm or more and 2.0 µm or less.

The primer layer can be formed by dispersing or dissolving the above-described material in an appropriate solvent to prepare a coating liquid, applying the coating liquid onto, for example, the substrate by the above-described application means to form a coating film, and drying the coating film.

### Release Layer

The release layer of the thermal transfer sheet is a layer disposed between the substrate and at least one layer selected from the discoloration-or decolorization-imparting layer, the peeling layer, the coloring material layer, and the protective layer and remains on the substrate during the thermal transfer of the thermal transfer sheet. The thermal transfer sheet including the release layer can improve transferability.

The release layer of the thermal transfer sheet may contain at least one resin material. Examples of the resin material contained in the release layer include (meth)acrylic resins, polyurethanes, acetal resins, polyamides, polyesters, melamine resins, polyol resins, cellulose resins, and silicone resins.

The release layer of the thermal transfer sheet may contain at least one release material. Examples of the release material include fluorine compounds, phosphate compounds, silicone oils, higher fatty acid amide compounds, metal soap, and waxes, such as paraffin wax.

The release layer of the thermal transfer sheet preferably has a release material content of 0.1% or more by mass and 10% or less by mass, more preferably 0.5% or more by mass and 5% or less by mass. This can further improve the transferability of the transfer layer.

The release layer of the thermal transfer sheet may contain the above-described additive.

The release layer of the thermal transfer sheet has a thickness of, for example, 0.1 µm or more and 2.0 µm or less.

The release layer of the thermal transfer sheet can be formed by dispersing or dissolving the above-described material in an appropriate solvent to prepare a coating liquid, applying the coating liquid onto, for example, the substrate by the above-described application means to form a coating film, and drying the coating film.

### Back Layer

The back layer is disposed on a side of the substrate opposite to the side on which the transfer layer is disposed. This can prevent the occurrence of sticking and wrinkling caused by heating during the thermal transfer.

The back layer may contain at least one resin material. Examples of the resin material contained in the back layer include vinyl resins, polyesters, polyamides, polyolefins, (meth)acrylic resins, polyolefins, polyurethanes, cellulose resins, and phenolic resins.

The back layer may contain at least one isocyanate compound. Examples of the isocyanate composition contained in the back layer include xylene diisocyanate, toluene diisocyanate, isophorone diisocyanate, and hexamethylene diisocyanate.

The back layer may contain the above-described release material and the above-described additive.

The back layer has a thickness of, for example, 0.01 µm or more and 3.0 µm or less.

The back layer can be formed by dispersing or dissolving the above-described material in an appropriate solvent to prepare a coating liquid, applying the coating liquid onto the substrate by the above-described application means to form a coating film, and drying the coating film.

### Combination of Thermal Transfer Sheet and Intermediate Transfer Medium

A combination of a thermal transfer sheet and an intermediate transfer medium according to the present disclosure is a combination of the thermal transfer sheet of the present disclosure and an intermediate transfer medium. In the combination of the present disclosure, the intermediate transfer medium includes at least a substrate and a retransfer layer, and the retransfer layer includes at least a receiving layer.

In the combination of the thermal transfer sheet of the present disclosure and the intermediate transfer medium, the “substrate”, the “peeling layer”, the “protective layer”, and the “release layer” included in the thermal transfer sheet may also be referred to as a “first substrate”, a “first peeling layer”, a “first protective layer”, and a “first release layer”, respectively. The “substrate”, a “peeling layer”, a “protective layer”, and a “release layer” included in the intermediate transfer medium may also be referred to as a “second substrate”, a “second peeling layer”, a “second protective layer”, and a “second release layer”, respectively.

The combination of the present disclosure will be described below with reference to the drawings.

In an embodiment, as illustrated in FIG. 10, a combination 30 of a thermal transfer sheet and an intermediate transfer medium includes a thermal transfer sheet 10 and an intermediate transfer medium 40. The thermal transfer sheet 10 includes the first substrate 11 and the transfer layer 12 (discoloration- or decolorization-imparting layer 13). The intermediate transfer medium 40 includes a second substrate 41 and a retransfer layer 42 (receiving layer 43).

The intermediate transfer medium 40 may include a second release layer (not illustrated) between the second substrate 41 and the retransfer layer 42.

The retransfer layer 42 of the intermediate transfer medium 40 may include the second peeling layer (not illustrated) and the receiving layer 43, and the second peeling layer may be disposed between the second substrate 41 and the receiving layer 43.

The retransfer layer 42 of the intermediate transfer medium 40 may include a second protective layer (not illustrated) and the receiving layer 43, and the second protective layer may be disposed between the second substrate 41 and the receiving layer 43.

The retransfer layer 42 of the intermediate transfer medium 40 may include the second peeling layer, the second protective layer, and the receiving layer 43 in this order. The second peeling layer and the second protective layer may be disposed between the second substrate 41 and the receiving layer 43 (not illustrated).

The above-described layer configurations of the combination 40 can be combined as appropriate.

In the above-described embodiment, examples of the transfer-receiving article include paper substrates, such as woodfree paper, art paper, coated paper, resin-coated paper, cast coated paper, paperboard, synthetic paper, and impregnated paper, resin films described below, laminates thereof, and cards.

Each layer that can be included in the intermediate transfer medium constituting the combination of the present disclosure will be described below. The thermal transfer sheet constituting the combination of the present disclosure has been described above and will not be described here.

### Second Substrate

The second substrate has heat resistance to thermal energy applied during thermal transfer of the intermediate transfer medium, mechanical strength that can support, for example, the retransfer layer disposed on the second substrate, and solvent resistance.

As the second substrate, the material used for the first substrate can be appropriately selected and used.

The second substrate has a thickness of, for example, 1 µm or more and 50 µm or less.

### Retransfer Layer

The retransfer layer of the combination of the present disclosure is a layer that includes at least the receiving layer. The retransfer layer is a layer to be transferred from the intermediate transfer medium by heating.

The retransfer layer of the combination of the present disclosure may include the second protective layer between the substrate and the receiving layer.

The retransfer layer of the combination of the present disclosure may include the second peeling layer between the substrate and the receiving layer or the second protective layer.

### Receiving Layer

The receiving layer of the combination of the present disclosure is a layer on which a general image and/or a discoloration- or decolorization-imparting image will be formed.

The receiving layer of the combination of the present disclosure may contain at least one resin material. Examples of the resin material contained in the receiving layer include polyolefins, vinyl resins, such as poly(vinyl chloride) and vinyl chloride-vinyl acetate copolymers, (meth)acrylic resins, cellulose resins, polyesters, polyamides, polycarbonates, styrene resins, epoxy resins, polyurethanes, and ionomer resins.

The receiving layer of the combination of the present disclosure preferably has a resin material content of 80% or more by mass and 99.5% or less by mass, more preferably 85% or more by mass and 99% or less by mass, based on the total component contained in the receiving layer.

The receiving layer of the combination of the present disclosure may contain the above-described additive.

The receiving layer of the combination of the present disclosure preferably has a thickness of 0.5 µm or more and 20 µm or less, more preferably 1 µm or more and 10 µm or less.

The receiving layer of the combination of the present disclosure can be formed by dispersing or dissolving the above-described material in an appropriate solvent to prepare a coating liquid, applying the coating liquid onto, for example, the second substrate, the second release layer, the second peeling layer, or the second protective layer by the above-described application means to form a coating film, and drying the coating film.

### Second Peeling Layer

The second peeling layer is a layer to be transferred from the intermediate transfer medium to the transfer-receiving article. The intermediate transfer medium including the second peeling layer can improve the transferability of the retransfer layer.

The second peeling layer may contain at least one resin material. Examples of the resin material contained in the second peeling layer include polyesters, polyamides, polyolefins, vinyl resins, (meth)acrylic resins, imide resins, cellulose resins, styrene resins, polycarbonates, and ionomer resins.

The second peeling layer may contain the above-described release material and the above-described additive.

The second peeling layer can be formed by dispersing or dissolving the above-described material in an appropriate solvent to prepare a coating liquid, applying the coating liquid onto, for example, the second substrate by the above-described application means to form a coating film, and drying the coating film.

### Second Protective Layer

The intermediate transfer medium including the second protective layer can protect the image of the thermal transfer printed material.

The second protective layer may contain at least one resin material. Examples of the resin material contained in the second protective layer include polyesters, (meth)acrylic resins, epoxy resins, styrene resins, acrylic polyol resins, polyurethanes, ionizing radiation-curable resins, and ultraviolet-absorbing resins.

The second protective layer may contain the above-described additive.

The second protective layer preferably has a thickness of 0.5 µm or more and 7 µm or less, more preferably 1 µm or more and 5 µm or less. This can further improve the durability of the second protective layer.

The second protective layer can be formed by dispersing or dissolving the above-described material in an appropriate solvent to prepare a coating liquid, applying the coating liquid onto, for example, the second substrate, the second release layer, or the second peeling layer by the above-described application means to form a coating film, and drying the coating film. The intermediate transfer medium includes the second release layer and thus can improve transferability.

### Second Release Layer

The second release layer is a layer disposed between the second substrate and the retransfer layer and remains on the second substrate during the thermal transfer of the intermediate transfer medium.

The second release layer may contain at least one resin material. Examples of the resin material contained in the second release layer include (meth)acrylic resins, polyurethanes, acetal resins, polyamides, polyesters, melamine resins, polyol resins, cellulose resins, and silicone resins.

The second release layer may contain at least one release material. Examples of the release material include fluorine compounds, phosphate compounds, silicone oils, higher fatty acid amide compounds, metal soap, and waxes, such as paraffin wax.

The second release layer preferably has a release material content of 0.1% or more by mass and 10% or less by mass, more preferably 0.5% or more by mass and 5% or less by mass. This can further improve the transferability of the retransfer layer.

The second release layer may contain the above-described additive.

The second release layer has a thickness of, for example, 0.1 µm or more and 2.0 µm or less.

The second release layer can be formed by dispersing or dissolving the above-described material in an appropriate solvent to prepare a coating liquid, applying the coating liquid onto, for example, the second substrate by the application means to form a coating film, and drying the coating film.

### Thermal Transfer Printed Material of First Form

A thermal transfer printed material of a first form includes a transfer-receiving article, a general image, and a discoloration- or decolorization-imparting image, in which the discoloration- or decolorization-imparting image is in contact with at least part of the general image. These allow the thermal transfer printed material to be able to discolor or decolorize the general image. Such thermal transfer printed materials are suitable for security cards and tickets, for example.

In this specification, the “thermal transfer printed material” refers to a printed material before the general image is discolored or decolorized by the light irradiation or heat treatment described above.

The thermal transfer printed material of the first form will be described below with reference to the drawings.

In an embodiment, as illustrated in FIG. 11, a thermal transfer printed material 50 includes a transfer-receiving article 51, a general image 52, and a discoloration- or decolorization-imparting image 53. As illustrated in FIG. 11, the discoloration- or decolorization-imparting image 53 is in contact with the general image 52.

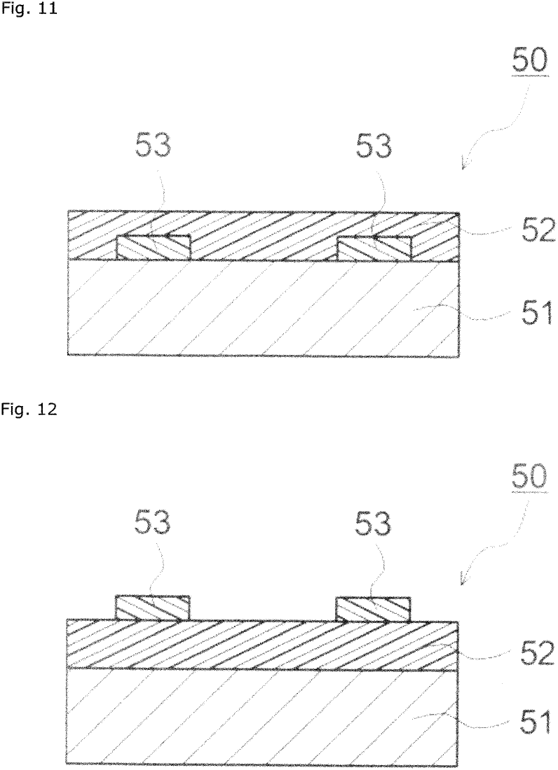

In an embodiment, as illustrated in FIG. 12, the thermal transfer printed material 50 includes the transfer-receiving article 51, the general image 52, and the discoloration- or decolorization-imparting image 53. As illustrated in FIG. 12, the discoloration- or decolorization-imparting image 53 is in contact with the general image 52 and disposed on the opposite side of the general image 52 from the transfer-receiving article 51.

In an embodiment, as illustrated in FIG. 13, the thermal transfer printed material 50 includes the transfer-receiving article 51, the general image 52, and the discoloration- or decolorization-imparting image 53. As illustrated in FIG. 13, the discoloration- or decolorization-imparting image 53 is in contact with the general image 52. As illustrated in FIG. 13, a protective layer 54 is disposed on the opposite side of the general image 52 from the transfer-receiving article 51.

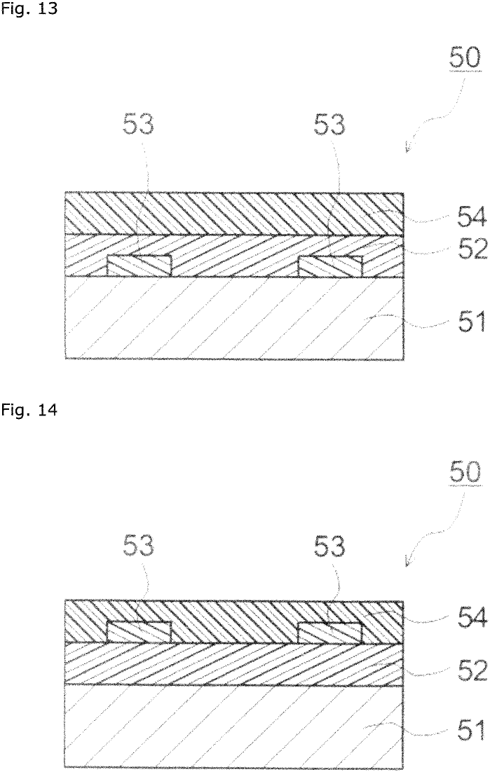

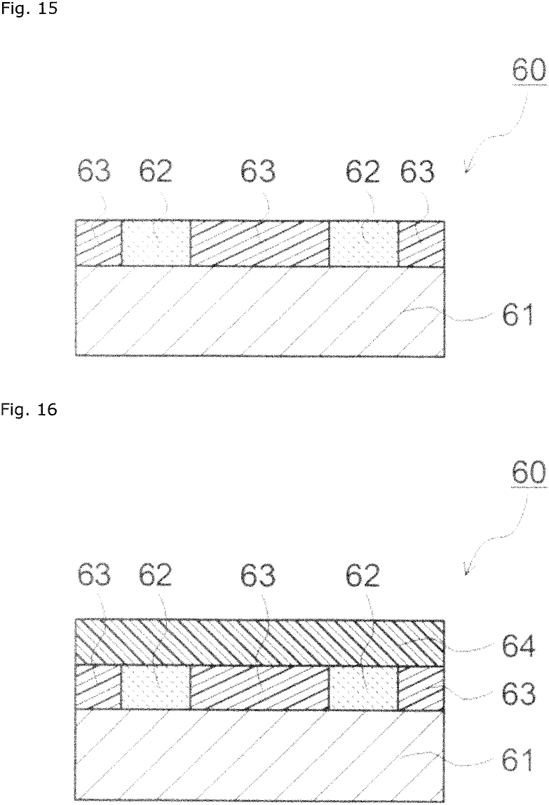

In an embodiment, as illustrated in FIG. 14, the thermal transfer printed material 50 includes the transfer-receiving article 51, the general image 52, and the discoloration- or decolorization-imparting image 53. As illustrated in FIG. 14, the discoloration- or decolorization-imparting image 53 is in contact with the general image 52 and disposed on the opposite side of the general image 52 from the transfer-receiving article 51. As illustrated in FIG. 14, the protective layer 54 is disposed on the opposite side of the general image 52 from the transfer-receiving article 51.

The above-described layer configurations of the thermal transfer printed material 50 can be combined as appropriate.

In an embodiment, a thermal transfer printed material of a first form contains a portion in which
a hue difference ΔE*ab is 5 or more between
a hue measured from the side of the general image and the discoloration- or decolorization-imparting image and
the hue of a portion corresponding to the portion measured, the hue being measured from the side of the general image and the discoloration- or decolorization-imparting image after the thermal transfer printed material is subjected to irradiation using a xenon lamp at an irradiation intensity of 1.2 W/m² for 24 hours from the side of the general image and the discoloration-or decolorization-imparting image.

The hue difference ΔE*ab is preferably 10 or more.

In an embodiment, a thermal transfer printed material of a first form contains a portion in which
a hue difference ΔE*ab is 5 or more between
a hue measured from the side of the general image and the discoloration- or decolorization-imparting image and
the hue of a portion corresponding to the portion measured, the hue being measured from the side of the general image and the discoloration- or decolorization-imparting image after the thermal transfer printed material is held at a temperature of 50° C. for 72 hours.

The hue difference ΔE*ab is preferably 10 or more.

In an embodiment, the hue measured from the side of the general image and the discoloration- or decolorization-imparting image is preferably one measured at a portion having a reflection density of 0.5 or more. The reflection density is measured from the side of the general image and the discoloration- or decolorization-imparting image of the thermal transfer printed material.

The reflection density is preferably 0.5 or more and 5 or less, more preferably 1.0 or more and 3 or less, even more preferably 1.5 or more and 1.7 or less.

In an embodiment, the lightness L* measured from the side of the general image and the discoloration- or decolorization-imparting image is preferably 5 or more and 100 or less.

The chromaticness index a* of the measured portion is preferably -90 or more and 100 or less.

The chromaticness index b* of the measured portion is preferably -80 or more and 120 or less.

In an embodiment, the lightness L* of a portion, corresponding to the measured portion before the irradiation, is preferably 15 or more and 100 or less when measured from the general image and the discoloration- or decolorization-imparting image after the irradiation using the xenon lamp at an irradiation intensity of 1.2 W/m² for 24 hours from the side of the general image and the discoloration- or decolorization-imparting image.

The chromaticness index a* of the measured portion is preferably -80 or more and 90 or less.

The chromaticness index b* of the measured portion is preferably -80 or more and 120 or less.

In an embodiment, the lightness L* of a portion, corresponding to the measured portion before the holding, is preferably 15 or more and 100 or less when measured from the general image and the discoloration- or decolorization-imparting image after holding the general image and the discoloration- or decolorization-imparting image at a temperature of 50° C. for 72 hours.

The chromaticness index a* of the measured portion is preferably -80 or more and 90 or less.

The chromaticness index b* of the measured portion is preferably -70 or more and 110 or less.

The thermal transfer printed material of the first form can be produced by using the thermal transfer sheet of the present disclosure.

Each layer that can be included in the thermal transfer printed material of the first form will be described below.

### Transfer-Receiving Article

The transfer-receiving article included in the thermal transfer printed material is not particularly limited. Examples of the transfer-receiving article include paper substrates, such as woodfree paper, art paper, coated paper, resin-coated paper, cast coated paper, paperboard, synthetic paper, and impregnated paper, resin films described below, laminates thereof, and cards.

The transfer-receiving article has a thickness of, for example, 0.1 mm or more and 2 mm or less.

### Discoloration- or Decolorization-Imparting Image

The discoloration- or decolorization-imparting image of the thermal transfer printed material of the first form is in contact with at least part of the general image and contains the compound responsible for discoloration or decolorization. The discoloration- or decolorization-imparting image may be a colored image or a colorless, transparent image, and is preferably a colorless, transparent image.

The discoloration- or decolorization-imparting image of the thermal transfer printed material of the first form may be disposed in whole or in part in the plane direction of the thermal transfer printed material. The discoloration- or decolorization-imparting image may be disposed in whole or in part on the general image and/or on the transfer-receiving article.

The discoloration- or decolorization-imparting image of the thermal transfer printed material of the first form may contain at least one resin material. Examples of the resin material contained in the discoloration- or decolorization-imparting image include polyolefins, vinyl resins, (meth)acrylic resins, cellulose resins, polyesters, epoxy resins, polyamides, polycarbonates, styrene resins, polyurethanes, phenoxy resins, and ionomer resins.

The discoloration- or decolorization-imparting image of the thermal transfer printed material of the first form can be formed from the discoloration- or decolorization-imparting layer of the thermal transfer sheet of the present disclosure.

### General Image

Examples of the general image of the thermal transfer printed material of the first form include photographs, characters, patterns, symbols, and combinations thereof. The general image contains the above-described coloring material.

The general image of the thermal transfer printed material of the first form may be disposed in whole or in part in the plane direction of the thermal transfer printed material. The general image may be disposed in whole or in part on the discoloration- or decolorization-imparting image and/or on the transfer-receiving article.

The general image of the thermal transfer printed material of the first form can be formed from the coloring material layer of the thermal transfer sheet of the present disclosure.

The general image of the thermal transfer printed material of the first form can be formed from the coloring material layer of a thermal transfer sheet different from the thermal transfer sheet of the present disclosure.

The general image of the thermal transfer printed material of the first form can be formed from a coloring material-containing ink by an ink-jet method.

### Protective Layer

The protective layer of the thermal transfer printed material of the first form is a layer to protect the image of the thermal transfer printed material.

The protective layer may be disposed on the opposite side of the general image and/or the discoloration- or decolorization-imparting image from the transfer-receiving article. The protective layer may be disposed at the outermost surface of the thermal transfer printed material.

The protective layer of the thermal transfer printed material of the first form may contain at least one resin material. Examples of the resin material contained in the protective layer include (meth)acrylic resins, polyesters, cellulose resins, styrene resins, polyamides, polyolefins, vinyl resins, imide resins, polycarbonates, ionomer resins, silicone resins, hydroxy group-containing resins, thermosetting resins, and actinic radiation-curable resins.

The protective layer of the thermal transfer printed material of the first form may contain the above-described additive. The protective layer of the thermal transfer printed material of the first form may contain the above-described release material.

The protective layer of the thermal transfer printed material of the first form has a resin material content of, for example, 50% or more by mass and 90% or less by mass.

In an embodiment, the protective layer of the thermal transfer printed material of the first form has a thickness of, for example, 0.1 µm or more and 13 µm or less. In an embodiment, the protective layer of the thermal transfer printed material of the first form may be formed of a single layer or multiple layers.

The protective layer of the thermal transfer printed material of the first form can be formed from the protective layer and/or the peeling layer of the thermal transfer sheet of the present disclosure.

### Method for Producing Thermal Transfer Printed Material of First Form

A method for producing the thermal transfer printed material of the first form includes the steps of providing the thermal transfer sheet of the present disclosure and a transfer-receiving article and forming a general image and a discoloration- or decolorization-imparting image on the transfer-receiving article in such a manner that the general image and the discoloration- or decolorization-imparting image are in contact with each other. The discoloration- or decolorization-imparting image is formed from the discoloration- or decolorization-imparting layer of the thermal transfer sheet of the present disclosure.

Each step included in the method for producing the thermal transfer printed material of the first form will be described below.

### Step of Providing Thermal Transfer Sheet and Transfer-Receiving Article

The method for producing the thermal transfer printed material of the first form includes the steps of providing the thermal transfer sheet of the present disclosure and the transfer-receiving article. Since the method for producing the thermal transfer sheet is as described above, the description thereof is omitted here.

Examples of the transfer-receiving article include those described above. The transfer-receiving article may be a commercially available product or may be produced by a method, such as a T-die method or an inflation method.

### Step of Forming General Image and Discoloration- or Decolorization-Imparting Image

The method for producing the thermal transfer printed material of the first form includes the step of forming the general image and the discoloration- or decolorization-imparting image on the transfer-receiving article in such a manner that the general image and the discoloration- or decolorization-imparting image are in contact with each other. In the image formation step, the discoloration- or decolorization-imparting image is formed from the discoloration- or decolorization-imparting layer of the thermal transfer sheet of the present disclosure.

In an embodiment, the image formation step is the step of forming the general image on the transfer-receiving article and then forming the discoloration- or decolorization-imparting image on the general image.

In an embodiment, the image formation step is the step of forming the discoloration- or decolorization-imparting image on the transfer-receiving article and then forming the general image on the discoloration- or decolorization-imparting image.

The formation of the general image may be performed using the thermal transfer sheet of the present disclosure or may be performed using a thermal transfer sheet different from the thermal transfer sheet of the present disclosure. The general image may be formed from the coloring material layer included in the thermal transfer sheet of the present disclosure or may be separately formed from, for example, a thermal transfer sheet including a coloring material layer.

The general image and the discoloration- or decolorization-imparting image may be formed by sublimation transfer or fusion transfer.

The general image may be formed by an ink-jet method using a coloring material-containing ink.

The general image and the discoloration- or decolorization-imparting image can be formed by a conventionally known method with, for example, a commercially available thermal transfer printer or an ink-jet printer.

### Discolored or Decolorized Printed Material of First Form

The discolored or decolorized printed material of the first form includes a transfer-receiving article and a discolored or decolorized portion.

In this specification, the “discolored or decolorized printed material” is a printed material after the general image has been discolored or decolorized by the light irradiation or heat treatment described above.

In an embodiment, the discolored or decolorized portion of the discolored or decolorized printed material of the first form contains a reaction product of a coloring material and a compound responsible for discoloration or decolorization.

The discolored or decolorized printed material of the first form will be described below with reference to the drawings.

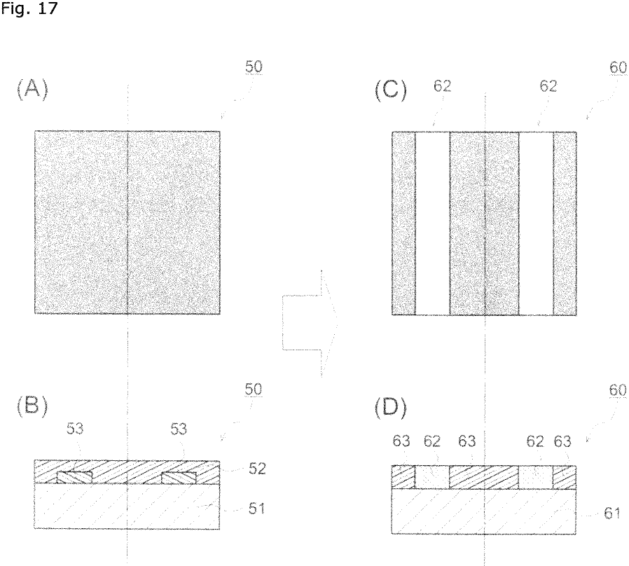

In an embodiment, as illustrated in FIG. 15, a discolored or decolorized printed material 60 includes a transfer-receiving article 61, a discolored or decolorized portion 62, and a general image 63.

In an embodiment, as illustrated in FIG. 16, the discolored or decolorized printed material 60 includes the transfer-receiving article 61, the discolored or decolorized portion 62, the general image 63, and a protective layer 64. As illustrated in FIG. 16, the protective layer 64 is disposed on the opposite side of the discolored or decolorized portion 62 and the general image 63 from the transfer-receiving article 61.

The discolored or decolorized printed material 60 may include a discoloration- or decolorization-imparting image (not illustrated) between the transfer-receiving article 61 and the general image 63 and/or on the opposite side of the general image 63 from the transfer-receiving article 61.

The above-described layer configurations of the discolored or decolorized printed material 60 can be combined as appropriate.

The discolored or decolorized printed material of the first form can be produced using the thermal transfer printed material of the first form.

Each layer that can be included in the discolored or decolorized printed material of the first form will be described below.

### Transfer-Receiving Article

As the transfer-receiving article of the discolored or decolorized printed material of the first form, the transfer-receiving article described in the thermal transfer printed material of the first form can be used.

### Discolored or Decolorized Portion

The discolored or decolorized portion is a portion where the general image has been discolored or decolorized by the light irradiation or heat treatment described above.

In an embodiment, the discolored or decolorized portion contains the reaction product of the coloring material contained in the general image and the compound responsible for discoloration or decolorization contained in the discoloration- or decolorization-imparting image. Examples of the reaction product include the reaction product of the coloring material and the compound responsible for discoloration or decolorization by the above-described light irradiation or the above-described heat treatment; and products obtained by initiation of the reaction of the coloring material due to the compound responsible for discoloration or decolorization and then decomposition, breakdown, or polymerization of the coloring material.

The discolored or decolorized portion of the discolored or decolorized printed material of the first form may contain at least one resin material. Examples of the resin material contained in the discolored or decolorized portion include polyolefins, vinyl resins, (meth)acrylic resins, cellulose resins, polyesters, epoxy resins, polyamides, polycarbonates, styrene resins, polyurethanes, phenoxy resins, and ionomer resins.

### Discoloration- or Decolorization-Imparting Image

The discoloration- or decolorization-imparting image of the discolored or decolorized transfer layer contains the compound responsible for discoloration or decolorization. The compound responsible for discoloration or decolorization contained in the discoloration- or decolorization-imparting image is, for example, an unreacted component that did not react with the coloring material by the light irradiation or heat treatment described above.

The discoloration- or decolorization-imparting image of the discolored or decolorized printed material of the first form may be disposed on the general image and/or the transfer-receiving article.

The discoloration- or decolorization-imparting image of the discolored or decolorized printed material of the first form may contain at least one resin material. Examples of the resin material contained in the discoloration- or decolorization-imparting image include polyolefins, vinyl resins, (meth)acrylic resins, cellulose resins, polyesters, epoxy resins, polyamides, polycarbonates, styrene resins, polyurethanes, phenoxy resins, and ionomer resins.

The discoloration- or decolorization-imparting image of the discolored or decolorized printed material of the first form can be formed from the discoloration- or decolorization-imparting image of the thermal transfer printed material of the first form.

### General Image

Examples of the general image of the discolored or decolorized transfer layer include photographs, characters, patterns, symbols, and combinations thereof. The general image of the discolored or decolorized transfer layer contains the above-described coloring material. The coloring material contained in the general image is, for example, an unreacted component that did not react with the compound responsible for discoloration or decolorization by the light irradiation or heat treatment described above.

The general image of the discolored or decolorized printed material of the first form may be disposed on the discoloration- or decolorization-imparting image and/or the transfer-receiving article.

The general image of the discolored or decolorized printed material of the first form can be formed from the general image of the thermal transfer printed material of the first form.

### Protective Layer

The protective layer of the discolored or decolorized printed material of the first form may be disposed on the opposite side of the discolored or decolorized portion from the transfer-receiving article. The protective layer may be disposed at the outermost surface of the discolored or decolorized printed material.

As the protective layer of the discolored or decolorized printed material of the first form, the protective layer described in the thermal transfer printed material of the first form can be used.

### Method for Producing Discolored or Decolorized Printed Material of First Form

In an embodiment, a method for producing the discolored or decolorized printed material of the first form includes a step of providing the thermal transfer printed material of the first form and a light irradiation step of irradiating the thermal transfer printed material of the first form with a light beam having a predetermined intensity for a predetermined period of time from the side of the thermal transfer printed material adjacent to the general image and the discoloration- or decolorization-imparting image to discolor or decolorize the general image.

In an embodiment, a method for producing the discolored or decolorized printed material of the first form includes a step of providing the thermal transfer printed material of the first form and a heat treatment step of holding the general image and the discoloration- or decolorization-imparting image of the thermal transfer printed material of the first form at a predetermined temperature for a predetermined period of time to discolor or decolorize the general image.

Each step included in the method for producing the discolored or decolorized printed material of the first form will be described below.

### Step of Providing Thermal Transfer Printed Material

The method for producing the discolored or decolorized printed material of the first form includes the step of providing the thermal transfer printed material for the first form. Since the method for producing the thermal transfer printed material is as described above, the description thereof is omitted here.

### Light Irradiation Step

In an embodiment, a method for producing the discolored or decolorized printed material of the first form includes a light irradiation step of irradiating the thermal transfer printed material of the first form with a light beam having a predetermined intensity for a predetermined period of time from the side of the general image and the discoloration- or decolorization-imparting image to discolor or decolorize the general image. The irradiation with the light beam having a predetermined intensity for a predetermined period of time is, for example, irradiation with a xenon lamp at an irradiation intensity of 0.1 W/m² or more for 0.1 seconds or more.

As illustrated in FIG. 17, when the thermal transfer printed material 50 is irradiated with light, part of the general image 52 is discolored or decolorized to form the discolored or decolorized portion 62. Thereby, the discolored or decolorized printed material 60 can be produced. In FIG. 17, (A) is a plan view of the thermal transfer printed material 50, (B) is a cross-sectional view of the thermal transfer printed material 50, (C) is a plan view of the discolored or decolorized printed material 60, and (D) is a cross-sectional view of the discolored or decolorized printed material 60.

The light irradiation intensity is preferably 0.1 W/m² or more and 5 W/m² or less, more preferably 0.1 W/m² or more and 3 W/m² or less. Thereby, the discolored or decolorized portion can be satisfactorily formed.

The light irradiation time is preferably 0.1 seconds or more and 2,160 hours or less, more preferably 1 second or more and 720 hours or less, even more preferably 1 hour or more and 240 hours or less. Thereby, the discolored or decolorized portion can be satisfactorily formed.

### Heat Treatment Step

In an embodiment, a method for producing the discolored or decolorized printed material of the first form includes a heat treatment step of holding the general image and the discoloration- or decolorization-imparting image of the thermal transfer printed material of the first form at a predetermined temperature for a predetermined period of time to discolor or decolorize the general image. An example of the holding at a predetermined temperature for a predetermined period of time is holding at a temperature of 50° C. or higher for 0.1 seconds or more.

As illustrated in FIG. 17, the thermal transfer printed material 50 is heat-treated to partially discolor or decolorize the general image 52 to form the discolored or decolorized portion 62. Thereby, the discolored or decolorized printed material 60 can be produced.

The heat treatment temperature is preferably 50° C. or higher and 100° C. or lower, more preferably 50° C. or higher and 80° C. or lower. Thereby, the discolored or decolorized portion can be satisfactorily formed.

The heat treatment time is 0.1 seconds or more and 2,160 hours or less, more preferably 24 hours or more and 720 hours or less, even more preferably 48 hours or more and 120 hours or less. Thereby, the discolored or decolorized portion can be satisfactorily formed.

### Thermal Transfer Printed Material of Second Form

A thermal transfer printed material of a second form includes a transfer-receiving article and a retransfer layer, in which the retransfer layer includes at least a receiving layer, a general image, and a discoloration- or decolorization-imparting image. In the thermal transfer printed material of the second form, the discoloration- or decolorization-imparting image is in contact with at least part of the general image. These allow the thermal transfer printed material to be able to discolor or decolorize the general image. Such thermal transfer printed materials are suitable for security cards and tickets, for example.

The thermal transfer printed material of the second form will be described below with reference to the drawings.

In an embodiment, as illustrated in FIG. 18, a thermal transfer printed material 70 includes a transfer-receiving article 71 and a retransfer layer 72, in which the retransfer layer 72 includes a general image 73, a discoloration-or decolorization-imparting image 74, and a receiving layer 75. As illustrated in FIG. 18, the discoloration- or decolorization-imparting image 74 is in contact with the general image 73. As illustrated in FIG. 18, the receiving layer 75 is disposed on the opposite side of the general image 73 from the transfer-receiving article 71.

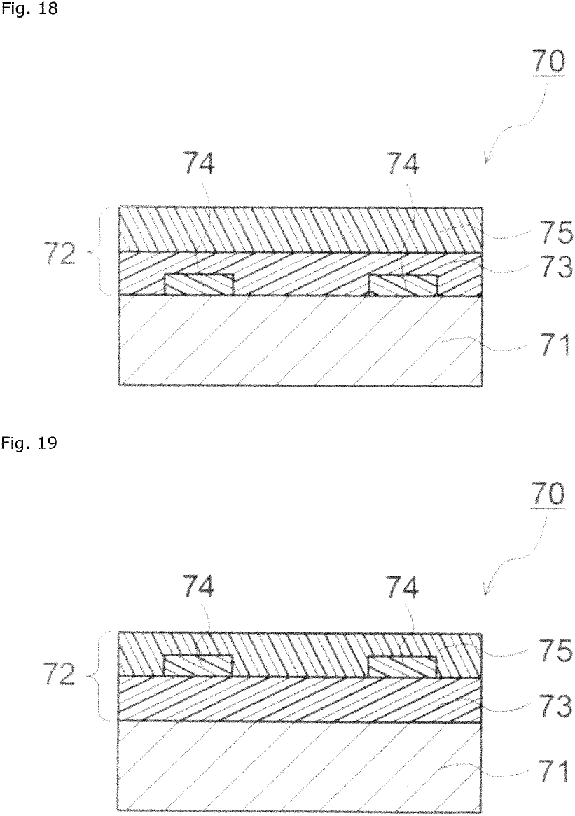

In an embodiment, as illustrated in FIG. 19, the thermal transfer printed material 70 includes the transfer-receiving article 71 and the retransfer layer 72, in which the retransfer layer 72 includes the general image 73, the discoloration- or decolorization-imparting image 74, and the receiving layer 75. As illustrated in FIG. 19, the discoloration- or decolorization-imparting image 74 is in contact with the general image 73 and disposed on the opposite side of the general image 73 from the transfer-receiving article 71. As illustrated in FIG. 19, the receiving layer 75 is disposed on the opposite side of the general image 73 from the transfer-receiving article 71.

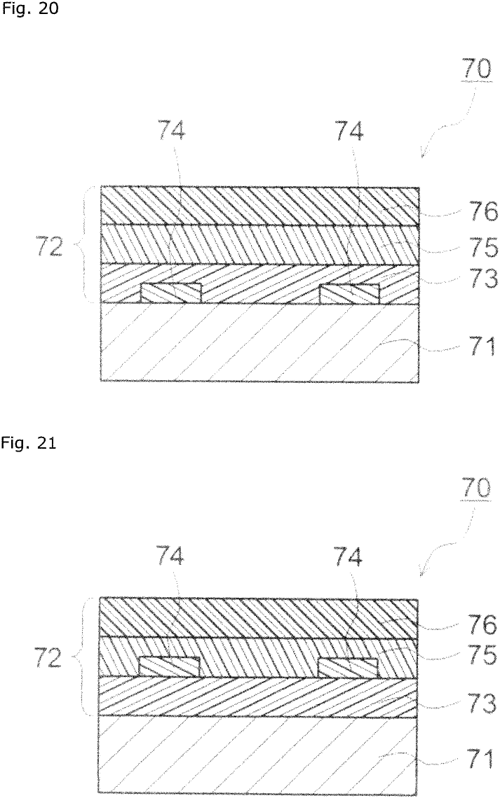

In an embodiment, as illustrated in FIG. 20, the thermal transfer printed material 70 includes the transfer-receiving article 71 and the retransfer layer 72, in which the retransfer layer 72 includes the general image 73, the discoloration- or decolorization-imparting image 74, the receiving layer 75, and a protective layer 76. As illustrated in FIG. 20, the discoloration- or decolorization-imparting image 74 is in contact with the general image 73. As illustrated in FIG. 20, the receiving layer 75 is disposed on the opposite side of the general image 73 from the transfer-receiving article 71. As illustrated in FIG. 20, the protective layer 76 is disposed on the opposite side of the receiving layer 75 from the general image 73.

In an embodiment, as illustrated in FIG. 21, the thermal transfer printed material 70 includes the transfer-receiving article 71 and the retransfer layer 72, in which the retransfer layer 72 includes the general image 73, the discoloration- or decolorization-imparting image 74, the receiving layer 75, and the protective layer 76. As illustrated in FIG. 21, the discoloration- or decolorization-imparting image 74 is in contact with the general image 73 and disposed on the opposite side of the general image 73 from the transfer-receiving article 71. As illustrated in FIG. 21, the receiving layer 75 is disposed on the opposite side of the general image 73 from the transfer-receiving article 71. As illustrated in FIG. 21, the protective layer 76 is disposed on the opposite side of the receiving layer 75 from the general image 73.

The above-described layer configurations of the thermal transfer printed material 70 can be combined as appropriate.

In an embodiment, the thermal transfer printed material of the second form contains a portion in which
a hue difference ΔE*ab is 5 or more between
a hue measured from the side of the retransfer layer and
the hue of a portion corresponding to the measured portion, the hue being measured from the side of the retransfer layer after the thermal transfer printed material is subjected to irradiation using a xenon lamp at an irradiation intensity of 1.2 W/m² for 24 hours from the side of the retransfer layer.

The hue difference ΔE*ab is preferably 10 or more.

In an embodiment, the thermal transfer printed material of the second form contains a portion in which
a hue difference ΔE*ab is 5 or more between
a hue measured from the side of the retransfer layer and
the hue of a portion corresponding to the measured portion, the hue being measured from the side of the retransfer layer after the thermal transfer printed material is held at a temperature of 50° C. for 72 hours.

The hue difference ΔE*ab is preferably 10 or more.

In an embodiment, the hue measured from the side of the retransfer layer is preferably one measured at a portion having a reflection density of 0.5 or more. The reflection density is measured from a side of the thermal transfer printed material adjacent to the retransfer layer.

The reflection density is preferably 0.5 or more and 5 or less, more preferably 1.0 or more and 3 or less, even more preferably 1.5 or more and 1.7 or less.

In an embodiment, the lightness L* measured from the side of the retransfer layer is preferably 5 or more and 100 or less.

The chromaticness index a* of the measured portion is preferably -90 or more and 100 or less.

The chromaticness index b* of the measured portion is preferably -80 or more and 120 or less.

In an embodiment, the lightness L* of a portion, corresponding to the measured portion before the irradiation, is preferably 15 or more and 100 or less when measured from the side of the retransfer layer after the irradiation using the xenon lamp at an irradiation intensity of 1.2 W/m² for 24 hours from the side of the retransfer layer.

The chromaticness index a* of the measured portion is preferably -80 or more and 90 or less.

The chromaticness index b* of the measured portion is preferably -80 or more and 120 or less.

In an embodiment, the lightness L* of a portion, corresponding to the measured portion before the holding, is preferably 15 or more and 100 or less when measured from the side of the retransfer layer after the holding at a temperature of 50° C. for 72 hours from the side of the retransfer layer.

The chromaticness index a* of the measured portion is preferably -80 or more and 90 or less.

The chromaticness index b* of the measured portion is preferably -70 or more and 110 or less.

The thermal transfer printed material of the second form can be produced using the combination of the thermal transfer sheet and the intermediate transfer medium according to the present disclosure.

Each layer that can be included in the thermal transfer printed material of the second form will be described below.

### Transfer-Receiving Article

As the transfer-receiving article of the thermal transfer printed material of the second form, the transfer-receiving article described in the thermal transfer printed material of the first form can be used.

### Retransfer Layer

The transfer layer of the thermal transfer printed material is a layer including at least a receiving layer, a general image, and a discoloration- or decolorization-imparting image. The receiving layer may be disposed on the opposite side of the general image from the transfer-receiving article.

The transfer layer of the thermal transfer printed material may include a protective layer on the opposite side of the receiving layer from the general image and/or the discoloration- or decolorization-imparting image. The protective layer may be disposed at the outermost surface of the thermal transfer printed material.

The retransfer layer of the thermal transfer printed material can be formed from the retransfer layer of the combination of the thermal transfer sheet and the intermediate transfer medium according to the present disclosure.

### Receiving Layer

The receiving layer of the thermal transfer printed material is a layer on which the general image and/or the discoloration- or decolorization-imparting image has been formed.

The receiving layer of the thermal transfer printed material may contain at least one resin material. Examples of the resin material contained in the receiving layer include polyolefins, vinyl resins, such as poly(vinyl chloride) and vinyl chloride-vinyl acetate copolymers, (meth)acrylic resins, cellulose resins, polyesters, polyamides, polycarbonates, styrene resins, epoxy resins, polyurethanes, and ionomer resins.

The receiving layer of the thermal transfer printed material preferably has a resin material content of 80% or more by mass and 99.5% or less by mass, more preferably 85% or more by mass and 99% or less by mass, based on the total component contained in the receiving layer.

The receiving layer of the thermal transfer printed material may contain the above-described additive.

The receiving layer of the thermal transfer printed material preferably has a thickness of 0.5 µm or more and 20 µm or less, more preferably 1 µm or more and 10 µm or less.

The receiving layer of the thermal transfer printed material can be formed from the receiving layer of the intermediate transfer medium of the combination of the thermal transfer sheet and the intermediate transfer medium according to the present disclosure.

### Discoloration- or Decolorization-Imparting Image

The discoloration- or decolorization-imparting image of the thermal transfer printed material of the second form is in contact with at least part of the general image and contains the compound responsible for discoloration or decolorization. The discoloration- or decolorization-imparting image may be a colored image or a colorless, transparent image, and is preferably a colorless, transparent image.

The discoloration- or decolorization-imparting image of the thermal transfer printed material of the second form may be disposed in whole or in part in the plane direction of the thermal transfer printed material. The discoloration- or decolorization-imparting image may be disposed in whole or in part on the general image and/or on the receiving layer.

The discoloration- or decolorization-imparting image of the thermal transfer printed material of the second form may contain at least one resin material. Examples of the resin material contained in the discoloration- or decolorization-imparting image include polyolefins, vinyl resins, (meth)acrylic resins, cellulose resins, polyesters, epoxy resins, polyamides, polycarbonates, styrene resins, polyurethanes, phenoxy resins, and ionomer resins.

The discoloration- or decolorization-imparting image of the thermal transfer printed material of the second form can be formed from the discoloration- or decolorization-imparting layer of the intermediate transfer medium of the combination of the thermal transfer sheet of the present disclosure and the intermediate transfer medium.

### General Image

Examples of the general image of the thermal transfer printed material of the second form include photographs, characters, patterns, symbols, and combinations thereof. The general image contains the above-described coloring material.

The general image of the thermal transfer printed material of the second form may be disposed in whole or in part in the plane direction of the thermal transfer printed material. The general image may be disposed in whole or in part on the discoloration- or decolorization-imparting image and/or the receiving layer.

The general image of the thermal transfer printed material of the second form can be formed from the coloring material layer of the thermal transfer sheet of the combination of the thermal transfer sheet and the intermediate transfer medium according to the present disclosure.

The general image of the thermal transfer printed material of the second form can be formed from the coloring material layer of a thermal transfer sheet of a combination different from the combination of the thermal transfer sheet and the intermediate transfer medium according to the present disclosure.

The general image of the thermal transfer printed material of the second form can be formed from a coloring material-containing ink by an ink-jet method.

### Protective Layer

As the protective layer of the thermal transfer printed material of the second form, the protective layer described in the thermal transfer printed material of the first form can be used.

### Method for Producing Thermal Transfer Printed Material of Second Form

In an embodiment, a method for producing the thermal transfer printed material of the second form includes the steps of providing the combination of the thermal transfer sheet and the intermediate transfer medium according to the present disclosure and the transfer-receiving article, forming the general image and the discoloration- or decolorization-imparting image on the receiving layer of the intermediate transfer medium in such a manner that the general image and the discoloration- or decolorization-imparting image are in contact with each other, and transferring the retransfer layer including at least the receiving layer, the general image, and the discoloration- or decolorization-imparting image to the transfer-receiving article. The discoloration- or decolorization-imparting image is formed from the discoloration- or decolorization-imparting layer of the thermal transfer sheet of the present disclosure.

Each step included in the method for producing the thermal transfer printed material of the second form will be described below.

### Step of Providing Combination of Thermal Transfer Sheet and Intermediate Transfer Medium and Transfer-Receiving Article

In an embodiment, the method for producing the thermal transfer printed material of the second form includes the steps of providing the combination of the thermal transfer sheet and the intermediate transfer medium according to the present disclosure and the transfer-receiving article. Methods of producing the thermal transfer sheet and the intermediate transfer medium in the combination have been described above; thus, the description thereof is omitted here.

Examples of the transfer-receiving article include those described above. The transfer-receiving article may be a commercially available product or may be produced by a method, such as a T die method or an inflation method.

### Step of Forming General Image and Discoloration- or Decolorization-Imparting Image

In an embodiment, a method for producing the thermal transfer printed material of the second form includes a step of forming the general image and the discoloration- or decolorization-imparting image on the receiving layer of the intermediate transfer medium in such a manner that the general image and the discoloration- or decolorization-imparting image are in contact with each other. In the image formation step, the discoloration- or decolorization-imparting image is formed from the discoloration- or decolorization-imparting layer of the thermal transfer sheet of the combination of the present disclosure.

In an embodiment, the image formation step is a step of forming the general image on the receiving layer of the intermediate transfer medium, and then forming the discoloration- or decolorization-imparting image on the general image.

In an embodiment, the image formation step is a step of forming the discoloration- or decolorization-imparting image on the receiving layer of the intermediate transfer medium, and then forming the general image on the discoloration- or decolorization-imparting image.

The general image may be formed using the thermal transfer sheet of the combination of the present disclosure, or may be formed using a thermal transfer sheet different from the thermal transfer sheet of the combination of the present disclosure. The general image may be formed from the coloring material layer included in the thermal transfer sheet of the combination of the present disclosure, or may be separately formed from, for example, a thermal transfer sheet including a coloring material layer.

The general image and the discoloration- or decolorization-imparting image may be formed by sublimation transfer or fusion transfer.

The general image may be formed by an ink-jet method using a coloring material-containing ink.

The general image and the discoloration- or decolorization-imparting image can be formed by a conventionally known method with, for example, a commercially available thermal transfer printer or an ink-jet printer.

The image formation step may be performed by sublimation transfer or fusion transfer.

### Step of Transferring Retransfer Layer

In an embodiment, a method for producing the thermal transfer printed material of the second form includes a step of transferring the retransfer layer including at least the receiving layer, the general image, and the discoloration- or decolorization-imparting image onto the transfer-receiving article.

The transfer can be performed by a conventionally known method with, for example, a commercially available thermal transfer printer.

### Discolored or Decolorized Printed Material of Second Form

The discolored or decolorized printed material of the second form includes a transfer-receiving article and a discolored or decolorized retransfer layer, in which the discolored or decolorized retransfer layer includes at least a receiving layer and a discolored or decolorized portion.

In an embodiment, with regard to the discolored or decolorized printed material of the second form, the discolored or decolorized portion contains a reaction product of a coloring material and a compound responsible for discoloration or decolorization.

The discolored or decolorized printed material of the second form will be described below with reference to the drawings.

In an embodiment, as illustrated in FIG. 22, a discolored or decolorized printed material 80 includes a transfer-receiving article 81 and a discolored or decolorized retransfer layer 82, in which the discolored or decolorized retransfer layer 82 includes a discolored or decolorized portion 83, a general image 84, and a receiving layer 85. As illustrated in FIG. 22, the receiving layer 85 is disposed on the opposite side of the discolored or decolorized portion 83 and the general image 84 from the transfer-receiving article 81.

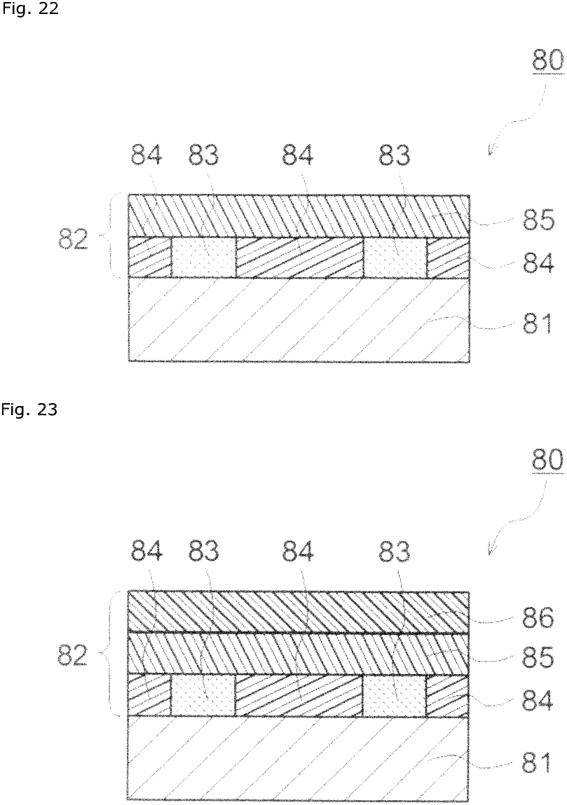

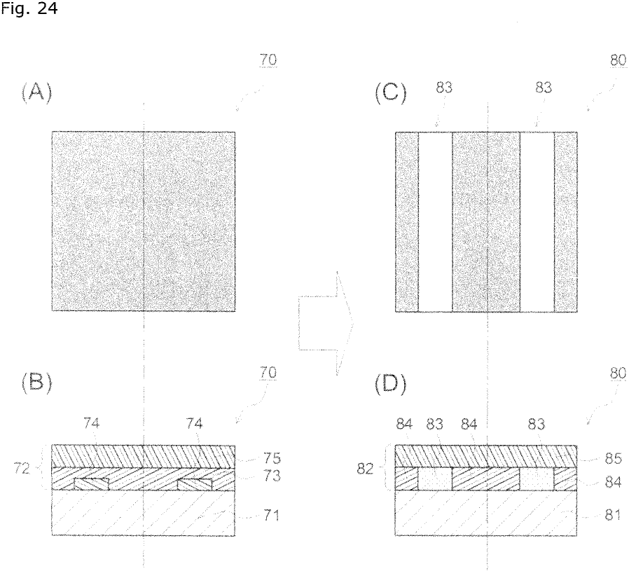

In an embodiment, as illustrated in FIG. 23, the discolored or decolorized printed material 80 includes the transfer-receiving article 81 and the discolored or decolorized retransfer layer 82, in which the discolored or decolorized retransfer layer 82 includes the discolored or decolorized portion 83, the general image 84, the receiving layer 85, and a protective layer 86. As illustrated in FIG. 23, the receiving layer 85 is disposed on the opposite side of the discolored or decolorized portion 83 and the general image 84 from the transfer-receiving article 81. As illustrated in FIG. 23, the protective layer 86 is disposed on the opposite side of the receiving layer 85 from the discolored or decolorized portion 83 and the general image 84.

The discolored or decolorized retransfer layer 82 of the discolored or decolorized printed material 80 may include a discoloration- or decolorization-imparting layer (not illustrated) between the transfer-receiving article 81 and the general image 84 and/or between the general image 84 and the receiving layer 85.

The above-described layer configurations of the discolored or decolorized printed material 80 can be combined as appropriate.

The discolored or decolorized printed material of the second form can be produced using the thermal transfer printed material of the second form.

Each layer that can be included in the discolored or decolorized printed material of the second form will be described below.

### Transfer-Receiving Article

As the transfer-receiving article of the discolored or decolorized printed material of the second form, the transfer-receiving article described in the thermal transfer printed material of the second form can be used.

### Discolored or Decolorized Retransfer Layer

The discolored or decolorized retransfer layer includes at least a receiving layer and a discolored or decolorized portion. The receiving layer may be disposed on the opposite side of the discolored or decolorized portion from the transfer-receiving article.

The discolored or decolorized retransfer layer may further include a general image and/or a discoloration- or decolorization-imparting image.

The discolored or decolorized retransfer layer may include a protective layer on the opposite side of the receiving layer from the discolored or decolorized portion. The protective layer may be disposed at the outermost surface of the thermal transfer printed material.

The discolored or decolorized retransfer layer can be formed from the retransfer layer of the thermal transfer printed material of the second form.

### Receiving Layer

The receiving layer of the discolored or decolorized printed material may include the general image and/or discoloration- or decolorization-imparting image.

The receiving layer of the discolored or decolorized printed material may contain at least one resin material. Examples of the resin material contained in the receiving layer include polyolefins, vinyl resins, such as poly(vinyl chloride) and vinyl chloride-vinyl acetate copolymers, (meth)acrylic resins, cellulose resins, polyesters, polyamides, polycarbonates, styrene resins, epoxy resins, polyurethanes, and ionomer resins.

The receiving layer of the discolored or decolorized printed material preferably has a resin material content of 80% or more by mass and 99.5% or less by mass, more preferably 85% or more by mass and 99% or less by mass, based on the total component contained in the receiving layer.

The receiving layer of the discolored or decolorized printed material may contain the above-described additive.

The receiving layer of the discolored or decolorized printed material preferably has a thickness of 0.5 µm or more and 20 µm or less, more preferably 1 µm or more and 10 µm or less.

### Discolored or Decolorized Portion

The discolored or decolorized portion is a portion where the general image has been discolored or decolorized by the light irradiation or heat treatment described above.

In an embodiment, the discolored or decolorized portion contains the reaction product of the coloring material contained in the general image and the compound responsible for discoloration or decolorization contained in the discoloration- or decolorization-imparting image. Examples of the reaction product include the reaction product of the coloring material and the compound responsible for discoloration or decolorization by the above-described light irradiation or the above-described heat treatment; and products obtained by initiation of the reaction of the coloring material due to the compound responsible for discoloration or decolorization and then decomposition, breakdown, or polymerization of the coloring material.

The discolored or decolorized portion of the discolored or decolorized printed material of the second form may contain at least one resin material. Examples of the resin material contained in the discolored or decolorized portion include polyolefins, vinyl resins, (meth)acrylic resins, cellulose resins, polyesters, epoxy resins, polyamides, polycarbonates, styrene resins, polyurethanes, phenoxy resins, and ionomer resins.

### Discoloration- or Decolorization-Imparting Image

The discoloration- or decolorization-imparting image of the discolored or decolorized retransfer layer contains the compound responsible for discoloration or decolorization. The compound responsible for discoloration or decolorization contained in the discoloration- or decolorization-imparting image is, for example, an unreacted component that did not react with the coloring material by the light irradiation or heat treatment described above.

The discoloration- or decolorization-imparting image of the discolored or decolorized printed material of the second form may be disposed on the general image and/or the receiving layer.

The discoloration- or decolorization-imparting image of the discolored or decolorized printed material of the second form may contain at least one resin material. Examples of the resin material contained in the discoloration- or decolorization-imparting image include polyolefins, vinyl resins, (meth)acrylic resins, cellulose resins, polyesters, epoxy resins, polyamides, polycarbonates, styrene resins, polyurethanes, phenoxy resins, and ionomer resins.

The discoloration- or decolorization-imparting image of the discolored or decolorized printed material of the second form can be formed from the discoloration- or decolorization-imparting image of the thermal transfer printed material of the second form.

### General Image

Examples of the general image of the discolored or decolorized retransfer layer include photographs, characters, patterns, symbols, and combinations thereof. The general image of the discolored or decolorized retransfer layer contains the above-described coloring material. The coloring material contained in the general image is, for example, an unreacted component that did not react with the compound responsible for discoloration or decolorization by the light irradiation or heat treatment described above.

The general image of the discolored or decolorized printed material of the second form may be disposed on the discoloration- or decolorization-imparting image and/or the receiving layer.

The general image of the discolored or decolorized printed material of the second form can be formed from the general image of the thermal transfer printed material of the second form.

### Protective Layer

The protective layer of the discolored or decolorized printed material of the second form may be disposed on the opposite side of the discolored or decolorized portion from the transfer-receiving article. The protective layer may be disposed at the outermost surface of the discolored or decolorized printed material.

As the protective layer of the discolored or decolorized printed material of the second form, the protective layer described in the thermal transfer printed material of the second form can be used.

### Method for Producing Discolored or Decolorized Printed Material of Second Form

In an embodiment, a method for producing the discolored or decolorized printed material of the second form includes a step of providing the thermal transfer printed material of the second form, and a light irradiation step of performing irradiation with a light beam having a predetermined intensity for a predetermined period of time from a side of the thermal transfer printed material of the second form adjacent to the retransfer layer to discolor or decolorize the general image.

In an embodiment, a method for producing the discolored or decolorized printed material of the second form includes a step of providing the thermal transfer printed material of the second form and a heat treatment step of holding the retransfer layer of the thermal transfer printed material of the second form at a predetermined temperature for a predetermined period of time to discolor or decolorize the general image.

Each step included in the method for producing the discolored or decolorized printed material of the second form will be described below.

### Step of Providing Thermal Transfer Printed Material

The method for producing the discolored or decolorized printed material of the second form includes the step of providing the thermal transfer printed material for the second form. Since the method for producing the thermal transfer printed material is as described above, the description thereof is omitted here.

### Light Irradiation Step

In an embodiment, the method for producing the discolored or decolorized printed material of the second form includes the light irradiation step of performing irradiation with the light beam having a predetermined intensity for a predetermined period of time from the side of the thermal transfer printed material of the second form adjacent to the retransfer layer to discolor or decolorize the general image. The irradiation with the light beam having a predetermined intensity for a predetermined period of time is, for example, irradiation with a xenon lamp at an irradiation intensity of 0.1 W/m² or more for 0.1 seconds or more.

As illustrated in FIG. 24, when the thermal transfer printed material 70 is irradiated with light, part of the general image 73 is discolored or decolorized to form the discolored or decolorized portion 83. Thereby, the discolored or decolorized printed material 80 can be produced. In FIG. 24, (A) is a plan view of the thermal transfer printed material 70, (B) is a cross-sectional view of the thermal transfer printed material 70, (C) is a plan view of the discolored or decolorized printed material 80, and (D) is a cross-sectional view of the discolored or decolorized printed material 70.

The light irradiation intensity is preferably 0.1 W/m² or more and 5 W/m² or less, more preferably 0.1 W/m² or more and 3 W/m² or less. Thereby, the discolored or decolorized portion can be satisfactorily formed.

The light irradiation time is preferably 0.1 seconds or more and 2,160 hours or less, more preferably 1 second or more and 720 hours or less, even more preferably 1 hour or more and 240 hours or less. Thereby, the discolored or decolorized portion can be satisfactorily formed.

### Heat Treatment Step

In an embodiment, the method for producing the discolored or decolorized printed material of the second form includes a heat treatment step of holding the thermal transfer printed material of the second form at a predetermined temperature for a predetermined period of time to discolor or decolorize the general image. An example of the holding at a predetermined temperature for a predetermined period of time is holding at a temperature of 50° C. or higher for 0.1 seconds or more.

As illustrated in FIG. 24, the thermal transfer printed material 70 is heat-treated to partially discolor or decolorize the general image 73 to form the discolored or decolorized portion 83. Thereby, the discolored or decolorized printed material 80 can be produced.

The heat treatment temperature is preferably 50° C. or higher and 100° C. or lower, more preferably 50° C. or higher and 80° C. or lower. Thereby, the discolored or decolorized portion can be satisfactorily formed.

The heat treatment time is 0.1 seconds or more and 2,160 hours or less, more preferably 24 hours or more and 720 hours or less, even more preferably 48 hours or more and 120 hours or less. Thereby, the discolored or decolorized portion can be satisfactorily formed.

Embodiments of the thermal transfer sheet, the combination of the thermal transfer sheet and the intermediate transfer medium, the thermal transfer printed material, a method for producing the thermal transfer printed material, the discolored or decolorized printed material, and a method for producing the discolored or decolorized printed material according to the present disclosure will be described below. The thermal transfer sheet, the combination of the thermal transfer sheet and the intermediate transfer medium, the thermal transfer printed material, the method for producing the thermal transfer printed material, the discolored or decolorized printed material, and the method for producing the discolored or decolorized printed material according to the present disclosure are not limited to these embodiments.

According to the present disclosure, a thermal transfer sheet includes a substrate and a transfer layer disposed on one surface side of the substrate,
in which the transfer layer includes at least a discoloration- or decolorization-imparting layer, and
the discoloration- or decolorization-imparting layer contains a compound responsible for discoloration or decolorization.

In an embodiment, the transfer layer further includes a peeling layer, and

the peeling layer is disposed between the substrate and the discoloration- or decolorization-imparting layer.

In an embodiment, the thermal transfer sheet further includes a coloring material layer,
in which the coloring material layer and the transfer layer are disposed as being frame sequentially on one surface.

In the thermal transfer sheet according to an embodiment,
a hue difference ΔE*ab is 5 or more between
the hue of a portion having a reflection density of 1.5 ± 0.1, the hue being measured from the side of a sublimation black image that has been formed on one surface side of a transfer-receiving article, and
the hue of a portion corresponding to the portion, the hue being measured, after irradiation using a xenon lamp at an irradiation intensity of 1.2 W/m² for 24 hours from the side of the sublimation black image and a discoloration- or decolorization-imparting image that has been formed on the sublimation black image from the discoloration- or decolorization-imparting layer, from the side of the sublimation black image and the discoloration- or decolorization-imparting image.

In the thermal transfer sheet according to an embodiment,
a hue difference ΔE*ab is 5 or more between
the hue of a portion having a reflection density of 1.5 ± 0.1, the hue being measured from the side of a sublimation black image that has been formed on one surface side of a transfer-receiving article, and
the hue of a portion corresponding to the portion, the hue being measured, after the sublimation black image and a discoloration- or decolorization-imparting image that has been formed on the sublimation black image from the discoloration- or decolorization-imparting layer are held at a temperature of 50° C. for 72 hours, from the side of the sublimation black image and the discoloration- or decolorization-imparting image.

In an embodiment, the compound responsible for discoloration or decolorization is at least one compound selected from acid-generating materials, chelating materials, and thermoplastic materials.

According to the present disclosure, a thermal transfer printed material includes a transfer-receiving article, a general image, and a discoloration- or decolorization-imparting image,

in which the discoloration- or decolorization-imparting image is in contact with at least part of the general image and contains a compound responsible for discoloration or decolorization.

In an embodiment, the thermal transfer printed material contains a portion in which
a hue difference ΔE*ab is 5 or more between
a hue measured from the side of the general image and the discoloration- or decolorization-imparting image and
the hue of a portion corresponding to the portion measured, the hue being measured from the side of the general image and the discoloration- or decolorization-imparting image after the thermal transfer printed material is subjected to irradiation using a xenon lamp at an irradiation intensity of 1.2 W/m² for 24 hours from the side of the general image and the discoloration-or decolorization-imparting image.

In an embodiment, the thermal transfer printed material contains a portion in which
a hue difference ΔE*ab is 5 or more between
a hue measured from the side of the general image and the discoloration- or decolorization-imparting image and
the hue of a portion corresponding to the portion measured, the hue being measured from the side of the general image and the discoloration- or decolorization-imparting image after the thermal transfer printed material is held at a temperature of 50° C. for 72 hours.

In an embodiment, the thermal transfer printed material is produced using the thermal transfer sheet described above.

According to the present disclosure, a method for producing the thermal transfer printed material described above includes the steps of:
providing the thermal transfer sheet described above and a transfer-receiving article; and
forming a general image and a discoloration- or decolorization-imparting image on the transfer-receiving article in such a manner that the general image and the discoloration- or decolorization-imparting image are in contact with each other,
in which the discoloration- or decolorization-imparting image is formed from the discoloration- or decolorization-imparting layer of the thermal transfer sheet.

According to the present disclosure, a discolored or decolorized printed material includes a transfer article and a discolored or decolorized portion, in which the discolored or decolorized portion contains a reaction product of a coloring material and a compound responsible for discoloration or decolorization.

In an embodiment, the discolored or decolorized printed material is produced using the thermal transfer printed material described above.

According to the present disclosure, a method for producing the discolored or decolorized printed material includes:
a step of providing the thermal transfer printed material; and
a light irradiation step of performing irradiation with a light beam having a predetermined intensity for a predetermined period of time from a side of the thermal transfer printed material adjacent to the general image and the discoloration- or decolorization-imparting image to discolor or decolorize the general image.

According to the present disclosure, a method for producing the discolored or decolorized printed material includes:
a step of providing the thermal transfer printed material; and
a heat treatment step of holding the general image and the discoloration- or decolorization-imparting image of the thermal transfer printed material at a predetermined temperature for a predetermined period of time to discolor or decolorize the general image.

According to the present disclosure, provided is a combination of the thermal transfer sheet described above and an intermediate transfer medium,
in which the intermediate transfer medium includes at least a substrate and a retransfer layer, and
the retransfer layer includes at least a receiving layer.

According to the present disclosure, a thermal transfer printed material includes a transfer-receiving article and a retransfer layer,
in which the retransfer layer includes at least a receiving layer, a general image, and a discoloration- or decolorization-imparting image, and
the discoloration- or decolorization-imparting image is in contact with at least part of the general image and contains a compound responsible for discoloration or decolorization.

In an embodiment, the thermal transfer printed material contains a portion in which
a hue difference ΔE*ab is 5 or more between
a hue measured from the side of the retransfer layer and
the hue of a portion corresponding to the measured portion, the hue being measured from the side of the retransfer layer after the thermal transfer printed material is subjected to irradiation using a xenon lamp at an irradiation intensity of 1.2 W/m² for 24 hours from the side of the retransfer layer.

In an embodiment, the thermal transfer printed material contains a portion in which
a hue difference ΔE*ab is 5 or more between
a hue measured from the side of the retransfer layer and
the hue of a portion corresponding to the portion measured, the hue being measured from the side of the retransfer layer after the retransfer layer of the thermal transfer printed material is held at a temperature of 50° C. for 72 hours.

In an embodiment, the thermal transfer printed material is produced using the above-described combination of the thermal transfer sheet and the intermediate transfer medium.

According to the present disclosure, a method for producing the thermal transfer printed material described above includes the steps of:
providing the combination of the thermal transfer sheet and the intermediate transfer medium described above and the transfer-receiving article;
forming the general image and the discoloration- or decolorization-imparting image on the receiving layer of the intermediate transfer medium in such a manner that the general image and the discoloration- or decolorization-imparting image are in contact with each other; and
transferring the retransfer layer including at least the receiving layer, the general image, and the discoloration- or decolorization-imparting image onto the transfer-receiving article,
in which the discoloration- or decolorization-imparting image is formed from the discoloration- or decolorization-imparting layer of the thermal transfer sheet.

According to the present disclosure, a discolored or decolorized printed material includes a transfer-receiving article and a discolored or decolorized retransfer layer,
in which the discolored or decolorized retransfer layer includes at least a receiving layer and a discolored or decolorized portion, and
the discolored or decolorized portion contains a reaction product of a coloring material and a compound responsible for discoloration or decolorization.

In an embodiment, the discolored or decolorized printed material is produced using the thermal transfer printed material.

According to the present disclosure, a method for producing the discolored or decolorized printed material described above includes:
a step of providing the thermal transfer printed material described above; and
a light irradiation step of irradiating the thermal transfer printed material with a light beam having a predetermined intensity from a side of the thermal transfer printed material adjacent to the retransfer layer for a predetermined period of time to discolor or decolorize the general image.

According to the present disclosure, a method for producing the discolored or decolorized printed material described above includes:
a step of providing the thermal transfer printed material described above; and
a heat treatment step of holding the retransfer layer of the thermal transfer printed material at a predetermined temperature for a predetermined period of time to discolor or decolorize the general image.

### EXAMPLES

While the present disclosure will be described in more detail below with reference to examples, the present disclosure is not limited to these examples. Hereinafter, with respect to a material in which the proportion of a solid content is described, a content before conversion into a solid content is indicated.

### Example 1

A PET film having a thickness of 4.5 µm was provided as a substrate. Then a coating liquid, having the following composition, for a primer layer was applied to part of one surface of this substrate and dried to form a primer layer having a thickness of 0.25 µm.

### Coating Liquid for Primer Layer

| | |
|---|---|
| Alumina sol | 3 parts by mass |
| (Alumina Sol 200, available from Nissan Chemical Industries, Ltd.) | |
| Vinyl acetate-vinylpyrrolidone copolymer | 7 parts by mass |
| (PVP/VA E-335, available from ISP Japan KK.) | |
| Water | 100 parts by mass |
| Isopropyl alcohol (IPA) | 100 parts by mass |

Coating liquids A to C, having the following compositions, for coloring material layers were applied on the primer layer in such a manner that the resulting coating layers were disposed as being frame sequentially on the same surface, and then dried to form coloring material layers A to C each having a thickness of 0.5 µm.

### Coating Liquid A for Coloring Material Layer

| | |
|---|---|
| Disperse Yellow 201 | 4 parts by mass |
| Polyvinyl acetal | 3.5 parts by mass |
| (S-LEC (registered trademark) KS-5, available from Sekisui Chemical Co., Ltd.) | |
| MEK | 46.65 parts by mass |
| Toluene | 46.65 parts by mass |

### Coating Liquid B for Coloring Material Layer

| | |
|---|---|
| Disperse Red 60G | 2 parts by mass |
| Disperse Violet 26 | 2 parts by mass |
| Disperse Red 343 | 2 parts by mass |
| Polyvinyl acetal | 3.5 parts by mass |
| (S-LEC (registered trademark) KS-5, available from Sekisui Chemical Co., Ltd.) | |
| MEK | 46.65 parts by mass |
| Toluene | 46.65 parts by mass |

### Coating Liquid C for Coloring Material Layer

| | |
|---|---|
| Solvent Blue 63 | 3.5 parts by mass |
| Disperse Blue 354 | 1 part by mass |
| Polyvinyl acetal | 3.5 parts by mass |
| (S-LEC (registered trademark) KS-5, available from Sekisui Chemical Co., Ltd.) | |
| MEK | 46.65 parts by mass |
| Toluene | 46.65 parts by mass |

A coating liquid, having the following composition, for a peeling layer was applied onto the surface of the substrate in such a manner that the resulting coating film and the primer layer were disposed as being frame sequentially on the same surface, and then dried to form a peeling layer having a thickness of 1 µm.

### Coating Liquid for Peeling Layer

| | |
|---|---|
| Acrylic resin | 40 parts by mass |
| (LP-45M, available from Soken Chemical & Engineering Co., Ltd.) | |
| MEK | 30 parts by mass |

| | |
|---|---|
| Toluene | 30 parts by mass |

A coating liquid, having the following composition, for a discoloration-or decolorization-imparting layer was applied onto part of a surface of the peeling layer and dried to form a discoloration- or decolorization-imparting layer having a thickness of 0.7 µm.

### Coating Liquid for Discoloration- or Decolorization-Imparting Layer

| | |
|---|---|
| Polyester | 27 parts by mass |
| (Elitel (registered trademark), available from Unitika Ltd.) | |
| Halide(2-(4-methoxystyryl)-4,6-bis(trichloromethyl)-1,3,5-triazine) | |
| | 3 parts by mass |
| (TAZ-110, nonionic, available from Midori Kagaku Co., Ltd.) | |
| MEK | 30 parts by mass |
| Toluene | 30 parts by mass |

A coating liquid, having the following composition, for an adhesive layer was applied onto another part of the surface of the peeling layer in such a manner that the resulting coating film and the coloring material layers were disposed as being frame sequentially on the same surface, and then dried to form an adhesive layer having a thickness of 1 µm.

### Coating Liquid for Adhesive Layer

| | |
|---|---|
| Polyester | 30 parts by mass |
| (Vylon (registered trademark) 200, available from Toyobo Co., Ltd.) | |
| Ultraviolet absorber | 2 parts by mass |
| (Tinuvin 928, available from BASF Japan Ltd.) | |
| MEK | 34 parts by mass |
| Toluene | 34 parts by mass |

A coating liquid, having the following composition, for a back layer was applied onto a surface of the PET film opposite to the surface on which the discoloration- or decolorization-imparting layer was disposed, and then dried to form a back layer having a thickness of 0.06 µm, thereby resulting in a thermal transfer sheet. The peeling layer and the discoloration- or decolorization-imparting layer constitute the transfer layer of the thermal transfer sheet. The peeling layer and the adhesive layer constitute the protective layer of the thermal transfer sheet.

### Coating Liquid for Back Layer

| | |
|---|---|
| Poly(vinyl butyral) | 3.6 parts by mass |
| (S-LEC (registered trademark) BX-1, available from Sekisui Chemical Co., Ltd. Co., Ltd.) | |
| Polyisocyanate | 8.4 parts by mass |
| (Burnock (registered trademark) D750, available from DIC Corporation) | |
| Phosphate surfactant | 2.8 parts by mass |
| (Plysurf (registered trademark) A208N, available from DKS Co., Ltd.) | |
| Talc | 0.6 parts by mass |
| (Micro Ace (registered trademark) P-3, available from Nippon Talc Co., Ltd.) | |
| Methyl ethyl ketone (MEK) | 42.3 parts by mass |
| Toluene | 42.3 parts by mass |

### Examples 2 to 10, Comparative Example 1, and Comparative Example 2

Thermal transfer sheets were produced as in Example 1, except that configurations of the layers constituting the thermal transfer sheets were changed as given in Table 1. In the thermal transfer sheet of Comparative example 1, the discoloration- or decolorization-imparting layer was not formed on the peeling layer.
Sulfonium compound A: CPI (registered trademark)-110P, ionic, available from San-Apro Ltd.)
Sulfonium compound B: CPI (registered trademark)-210S, ionic, available from San-Apro Ltd.)
Sulfonium compound C: TA100, ionic, available from San-Apro Ltd.)
Iodonium compound: IK-1, ionic, available from San-Apro Ltd.)
Thermoplastic material: bis(3-ethylhexyl) phthalate (DOP)
Phosphate: Plysurf (registered trademark) A208N, available from Dai-ichi Seiyaku Kogyo Co., Ltd.
Chelating material: one with the following structure

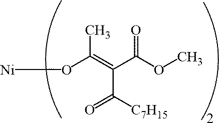

### Example 11

A thermal transfer sheet was produced as in Example 1, except that the order of the coloring material layers and the discoloration- or decolorization-imparting layer in the plane direction of the thermal transfer sheet of Example 1 was changed to the order of the discoloration- or decolorization-imparting layer and the coloring material layer and that the peeling layer between the substrate and the discoloration- or decolorization-imparting layer was changed to a release layer. With regard to the release layer, a coating liquid, having the following composition, for a release layer was applied and dried to form a release layer having a thickness of 0.1 µm.

### Coating Liquid for Release Layer

| | |
|---|---|
| Acrylic silicone graft polymer | 10 parts by mass |
| (SYMAC (registered trademark) US350, available from Toagosei Co., Ltd.) | |
| MEK | 20 parts by mass |
| Toluene | 20 parts by mass |

### Examples 12 and 13

Thermal transfer sheets were produced as in Example 11, except that the configurations of the layers constituting the thermal transfer sheets were changed as given in Table 1.

### Example 14

A thermal transfer sheet of Example 14 is the same as the thermal transfer sheet of Example 1.

### Example 15

A thermal transfer sheet of Example 15 is the same as the thermal transfer sheet of Example 4.

### Example 16

A thermal transfer sheet of Example 16 is the same as the thermal transfer sheet of Example 7.

### Example 17

A thermal transfer sheet of Example 17 is the same as the thermal transfer sheet of Example 9.

### Example 18

A thermal transfer sheet of Example 18 is the same as the thermal transfer sheet of Example 10.

### Production of Thermal Transfer Printed Material of First Form

Using the thermal transfer sheet obtained in each of Examples 1 to 10 and Comparative examples 1 and 2, black printing was performed on image-receiving paper for a thermal transfer printer (DS620), available from Dai Nippon Printing Co., Ltd., with the following evaluation printer, thereby forming a general image. The black printing was performed by superimposing the coloring material layers A to C. Subsequently, a discoloration- or decolorization-imparting image composed of a discoloration- or decolorization-imparting layer and a peeling layer was formed on the general image. Furthermore, a protective layer composed of a peeling layer and an adhesive layer was transferred to form a thermal transfer printed material of a first form.

In the case of using the thermal transfer sheet obtained in each of Examples 11 to 13, a discoloration- or decolorization-imparting image composed of a discoloration- or decolorization-imparting layer was formed on the image-receiving paper with the following evaluation printer. Then black printing was performed on the discoloration- or decolorization-imparting image to form a general image. Furthermore, a protective layer composed of a peeling layer and an adhesive layer was transferred to form a thermal transfer printed material of a first form.

### Evaluation Printer

Thermal head: F3598 (available from Toshiba Hokuto Electronics Corporation)
Average resistance of heating element: 5,015 (Ω)
Print density in main-scanning direction: 300 (dpi)
Print density in sub-scanning direction: 300 (dpi)
Printing power: 0.13 (W/dot)
Applied voltage: 25.5 (V)
Line period: 2 (msec./line)
Pulse duty: 85%

### Production of Thermal Transfer Printed Material of Second Form

### Production of Intermediate Transfer Medium

A PET film having a thickness of 12 µm was separately provided as a second substrate. A coating liquid, having the same composition as in Example 1, for a second peeling layer was applied onto part of a surface of the second substrate and dried to form a second peeling layer having a thickness of 1 µm.

A coating liquid, having the following composition, for a receiving layer was applied onto the second peeling layer and dried to form a receiving layer having a thickness of 1 µm, thereby resulting in an intermediate transfer medium. The peeling layer and the receiving layer constitute a retransfer layer of the intermediate transfer medium.

### Coating Liquid for Receiving Layer

| | |
|---|---|
| Vinyl chloride-vinyl acetate copolymer | 95 parts by mass |

(Solbin (registered trademark) CNL, Tg: 76° C., Mn: 16,000, available from Nissin Chemical Industry Co., Ltd.)

| | |
|---|---|
| Toluene | 200 parts by mass |
| MEK | 200 parts by mass |

The thermal transfer sheets obtained in Examples 14 to 18, the intermediate transfer media, poly(vinyl chloride) (PVC) cards (50 mm wide × 70 mm long, available from Dai Nippon Printing Co., Ltd.), and the evaluation printer were provided.

Using the foregoing printer, a general image was formed on the receiving layer of each of the intermediate transfer media using the coloring material layers of each of the thermal transfer sheets, and a discoloration-or decolorization-imparting image was formed on the receiving layer using the transfer layer composed of the discoloration- or decolorization-imparting layer and the peeling layer.

The retransfer layer, including the receiving layer on which the general image and the discoloration- or decolorization-imparting image had been formed, of the intermediate transfer medium was transferred onto the PVC card to produce a thermal transfer printed material of a second form.

### Measurement of Optical Density and Hue

The reflection densities (OD) and hues L*, a*, and b* of the resulting thermal transfer printed materials were measured under the following colorimetric conditions.

### Colorimetric Conditions

Spectrometer: i1Pro2 (available from X-Rite Inc.)
Density status: Status A
Light source: D65
Measurement field of view: 2°
Measurement illumination conditions: M0 (ISO 13655-2009)

### Evaluation of Hue Change

The hues L*, a*, and b* of the resulting thermal transfer printed materials were measured with the spectrometer (ilPro2, available from X-Rite Inc.,), where L*, a*, and b* are based on the CIE 1976 L*a*b* color system (JIS Z 8729 (published in 1980), L* represents lightness, and a* and b* represent chromaticness indices.

Each of the thermal transfer printed materials is subjected to light irradiation or heat treatment under the following conditions for evaluating the discoloration or decolorization properties. The hues are measured again after the irradiation. The hue difference ΔE*ab is calculated from the following formula.

Hue difference ΔE*ab = (L* after discoloration or decolorization - L* before discoloration or decolorization)² + (a* after discoloration or decolorization - a* before discoloration or decolorization)² + (b* after discoloration or decolorization - b* before discoloration or decolorization)²)^{½}

### Evaluation of Discoloration or Decolorization Properties (Light Irradiation

Irradiation with a xenon lamp was performed for 24 hours under the following conditions from the opposite side of the thermal transfer printed material from the image-receiving paper or the PVC card. The hues of the discolored or decolorized printed material were measured. The hue difference ΔE*ab was calculated and evaluated on the basis of the following evaluation criteria. Table 1 presents the evaluation results.

### Light Irradiation Conditions

Irradiation tester: xenon weather meter (Ci4000, available from Atlas)
Light source: xenon lamp
Filter: inner = CIRA, outer = soda lime
Black panel temperature: 45 (°C)
Irradiation intensity: 1.2 (W/m²), measured value at 420 (nm)

### Evaluation Criteria

A: The hue difference ΔE*ab was 10 or more.

B: The hue difference ΔE*ab was 5 or more and less than 10.

C: The hue difference ΔE*ab was less than 5.

### Evaluation of Discoloration or Decolorization Properties (Heat Treatment

Each of the thermal transfer printed materials was held at a temperature 50° C. for 72 hours. The hues of the resulting discolored or decolorized printed material were measured. The hue difference ΔE*ab was calculated and evaluated on the basis of the following evaluation criteria.

Table 1 presents the evaluation results.

### Evaluation Criteria

A: The hue difference ΔE*ab was 10 or more.

B: The hue difference ΔE*ab was 5 or more and less than 10.

C: The hue difference ΔE*ab was less than 5.

TABLE 1

| Table 1 | Type and amount of compound responsible for discoloration or decolorization contained in discoloration- or decolorization-imparting layer (% by mass) | | | | | | | | Binder content of discoloration- or decolorization-imparting layer (% by mass) | Reflection density (Bk) of thermal transfer printed material before irradiation | Evaluation of discoloration or decolorization properties | |
|---|---|---|---|---|---|---|---|---|---|---|---|---|
| | Halide | Sulfonium compound A | Sulfonium compound B | Sulfonium compound C | Iodonium compound | Chelating material | Thermoplastic material | Phosphate | | | Light irradiation | Heat treatment |
| Example 1 | 10 | | | | | | | | 90 | 1.5 | A | C |
| Example 2 | 5 | | | | | | | | 95 | 1.5 | A | C |
| Example 3 | 20 | | | | | | | | 80 | 1.5 | A | C |
| Example 4 | | 10 | | | | | | | 90 | 1.5 | A | C |
| Example 5 | | 20 | | | | | | | 80 | 1.5 | A | C |
| Example 6 | | | 10 | | | | | | 90 | 1.5 | A | C |
| Example 7 | | | | 10 | | | | | 90 | 1.5 | C | B |
| Example 8 | | | | | 10 | | | | 90 | 1.5 | C | B |
| Example 9 | | | | | | 10 | | | 90 | 1.5 | C | B |
| Example 10 | | | | | | | 50 | | 50 | 1.5 | C | B |
| Example 11 | 10 | | | | | | | | 90 | 1.5 | A | C |
| Example 12 | | 10 | | | | | | | 90 | 1.5 | A | C |
| Example 13 | | | | 10 | | | | | 90 | 1.5 | C | B |
| Example 14 | 10 | | | | | | | | 90 | 1.5 | A | C |
| Example 15 | | 10 | | | | | | | 90 | 1.5 | A | C |
| Example 16 | | | | 10 | | | | | 90 | 1.5 | C | B |
| Example 17 | | | | | | 10 | | | 90 | 1.5 | C | B |
| Example 18 | | | | | | | 50 | | 50 | 1.5 | A | C |
| Comparative example 1 | | | | | | | | | 100 | 1.5 | C | C |
| Comparative example 2 | | | | | | | | 10 | 90 | 1.5 | C | C |

It should be understood by those skilled in the art that the thermal transfer sheet and the like of the present disclosure are not limited by the description of the above examples, but the above examples and specification are merely for illustrating the principle of the present disclosure, and various modifications or improvements can be made without departing from the spirit and scope of the present disclosure, and all of these modifications or improvements fall within the scope of the present disclosure as claimed. Furthermore, the scope of protection claimed by the present disclosure includes not only the description of the claims but also the equivalents thereof.

### REFERENCE SIGNS LIST

10: thermal transfer sheet, 11: substrate (first substrate), 12: transfer layer, 13: discoloration- or decolorization-imparting layer, 14: peeling layer (first peeling layer), 15: coloring material layer, 16: protective layer (first protective layer), 30: combination of thermal transfer sheet and intermediate transfer medium, 40: intermediate transfer medium, 41: substrate (second substrate), 42: retransfer layer, 43: receiving layer (second receiving layer), 50: thermal transfer printed material, 51: transfer-receiving article, 52: general image, 53: discoloration- or decolorization-imparting image, 54: protective layer, 60: discolored or decolorized printed material, 61: transfer-receiving article, 62: discolored or decolorized portion, 63: general image, 64: protective layer, 70: thermal transfer printed material, 71: transfer-receiving article, 72: retransfer layer, 73: general image, 74: discoloration- or decolorization-imparting image, 75: receiving layer, 76: protective layer, 80: discolored or decolorized printed material, 81: transfer-receiving article, 82: discolored or decolorized retransfer layer, 83: discolored or decolorized portion, 84: general image, 85: receiving layer, 86: protective layer

1. A thermal transfer sheet, comprising a substrate, and a coloring material layer and a transfer layer disposed on one surface side of the substrate,
wherein the transfer layer includes at least a discoloration- or decolorization-imparting layer,
the discoloration- or decolorization-imparting layer contains a compound responsible for discoloration or decolorization, the compound having a function of discoloring or decoloring a general image, and
the coloring material layer and the transfer layer are disposed as being frame sequentially on one surface.

2. The thermal transfer sheet according to claim 1, wherein the transfer layer further includes a peeling layer, and
the peeling layer is disposed between the substrate and the discoloration- or decolorization-imparting layer.

3. (canceled)

4. The thermal transfer sheet according to claim 1, wherein a hue difference ΔE*ab is 5 or more between
a hue of a portion having a reflection density of 1.5 ± 0.1, the hue being measured from a side of a sublimation black image that has been formed on one surface side of a transfer-receiving article, and
a hue of a portion corresponding to the portion, the hue being measured, after irradiation using a xenon lamp at an irradiation intensity of 1.2 W/m² for 24 hours from a side of the sublimation black image and a discoloration- or decolorization-imparting image containing the compound responsible for discoloration or decolorization that has been formed on the sublimation black image from the discoloration- or decolorization-imparting layer, from the side of the sublimation black image and the discoloration- or decolorization-imparting image.

5. The thermal transfer sheet according to claim 1, wherein a hue difference ΔE*ab is 5 or more between
a hue of a portion having a reflection density of 1.5 ± 0.1, the hue being measured from a side of a sublimation black image that has been formed on one surface side of a transfer-receiving article, and
a hue of a portion corresponding to the portion, the hue being measured, after the sublimation black image and a discoloration- or decolorization-imparting image containing the compound responsible for discoloration or decolorization that has been formed on the sublimation black image from the discoloration- or decolorization-imparting layer are held at a temperature of 50° C. for 72 hours, from a side of the sublimation black image and the discoloration- or decolorization-imparting image.

6. The thermal transfer sheet according to claim 1, wherein the compound responsible for discoloration or decolorization is at least one compound selected from acid-generating materials, chelating materials, and thermoplastic materials.

7. A method for producing a thermal transfer printed material comprising the steps of:
providing the thermal transfer sheet according to claim 1 and a transfer-receiving article; and
forming a general image and a discoloration- or decolorization-imparting image on the transfer-receiving article in such a manner that the general image and the discoloration- or decolorization-imparting image are in contact with each other,
wherein the discoloration- or decolorization-imparting image is formed from the discoloration- or decolorization-imparting layer of the thermal transfer sheet,
wherein the thermal transfer printed material, includes the transfer-receiving article, the general image, and the discoloration-or decolorization-imparting image,
wherein the transfer-receiving article includes a receiving layer, and the general image and/or the discoloration- or decolorization-imparting image are disposed on the receiving layer,
the general image is a thermal transfer image, and
the discoloration- or decolorization-imparting image is in contact with at least part of the general image and contains a compound responsible for discoloration or decolorization, the compound having a function of discoloring or decolorizing the general image.

8. The method for producing the thermal transfer printed material according to claim 7, wherein the thermal transfer printed material contains a portion in which a hue difference ΔE*ab is 5 or more between
a hue measured from a side of the general image and the discoloration- or decolorization-imparting image and
a hue of a portion corresponding to the portion measured, the hue being measured from the side of the general image and the discoloration- or decolorization-imparting image after the thermal transfer printed material is subjected to irradiation using a xenon lamp at an irradiation intensity of 1.2 W/m² for 24 hours from the side of the general image and the discoloration-or decolorization-imparting image.

9. The thermal transfer printed material according to claim 7, wherein the thermal transfer printed material contains a portion in which a hue difference ΔE*ab is 5 or more between
a hue measured from a side of the general image and the discoloration- or decolorization-imparting image and
a hue of a portion corresponding to the portion measured, the hue being measured from the side of the general image and the discoloration- or decolorization-imparting image after the thermal transfer printed material is held at a temperature of 50° C. for 72 hours.

10. (canceled)

11. (canceled)

12. (canceled)

13. (canceled)

14. (canceled)

15. (canceled)

16. A combination of the thermal transfer sheet according to claim 1 and an intermediate transfer medium,
wherein the intermediate transfer medium includes at least a substrate and a retransfer layer, and
the retransfer layer includes at least a receiving layer.

17. A thermal transfer printed material, comprising a transfer-receiving article and a retransfer layer,
wherein the retransfer layer includes at least a receiving layer, a general image, and a discoloration- or decolorization-imparting image, and
the discoloration- or decolorization-imparting image is in contact with at least part of the general image and contains a compound responsible for discoloration or decolorization, the compound having a function of discoloring or decolorizing the general image.

18. The thermal transfer printed material according to claim 17, wherein the thermal transfer printed material contains a portion in which a hue difference ΔE*ab is 5 or more between
a hue measured from a side of the retransfer layer and
a hue of a portion corresponding to the portion measured, the hue being measured from the side of the retransfer layer after the thermal transfer printed material is subjected to irradiation using a xenon lamp at an irradiation intensity of 1.2 W/m² for 24 hours from the side of the retransfer layer.

19. The thermal transfer printed material according to claim 17, wherein the thermal transfer printed material contains a portion in which a hue difference ΔE*ab is 5 or more between
a hue measured from a side of the retransfer layer and
a hue of a portion corresponding to the portion measured, the hue being measured from the side of the retransfer layer after the retransfer layer of the thermal transfer printed material is held at a temperature of 50° C. for 72 hours.

20. (canceled)

21. A method for producing the thermal transfer printed material according to claim 17, comprising the steps of:
providing a combination of a thermal transfer sheet and an intermediate transfer medium and the transfer-receiving article,
wherein the thermal transfer sheet includes a substrate, and a coloring material layer and a transfer layer disposed on one surface side of the substrate,
the transfer layer includes at least a discoloration- or decolorization- imparting layer,
the discoloration- or decolorization-imparting layer contains a compound responsible for discoloration or decolorization, the compound having a function of discoloring or decolorizing a general image, and
the coloring material layer and the transfer layer are disposed as being frame sequentially on one surface,
wherein the intermediate transfer medium includes at least a substrate and a retransfer layer, and
the retransfer layer includes at least a receiving layer;
forming the general image and the discoloration- or decolorization-imparting image on the receiving layer of the intermediate transfer medium in such a manner that the general image and the discoloration- or decolorization-imparting image are in contact with each other; and
transferring the retransfer layer including at least the receiving layer, the general image, and the discoloration- or decolorization-imparting image onto the transfer-receiving article,
wherein the discoloration- or decolorization-imparting image is formed from the discoloration- or decolorization-imparting layer of the thermal transfer sheet.

22. A discolored or decolorized printed material, comprising a transfer-receiving article and a discolored or decolorized retransfer layer,
wherein the discolored or decolorized retransfer layer includes at least a receiving layer and a discolored or decolorized portion, and
the discolored or decolorized portion contains a reaction product of a coloring material and a compound responsible for discoloration or decolorization, the compound having a function of discoloring or decolorizing a general image.

23. (canceled)

24. A method for producing the discolored or decolorized printed material according to claim 22, comprising:
a step of providing thermal transfer printed material including a transfer-receiving article and a retransfer layer,
wherein the retransfer layer includes at least a receiving layer, a general image, and a discoloration- or decolorization-imparting image, and
the discoloration- or decolorization-imparting image is in contact with at least part of the general image and contains a compound responsible for discoloration or decolorization, the compound having a function of discoloring or decolorizing the general image; and
a light irradiation step of performing irradiation with a light beam having a predetermined intensity for a predetermined period of time from a side of the thermal transfer printed material adjacent to the retransfer layer to discolor or decolorize the general image.

25. A method for producing the discolored or decolorized printed material according to claim 22, comprising:
a step of providing a thermal transfer printed material including a transfer-receiving article and a retransfer layer,
wherein the retransfer layer includes at least a receiving layer, a general image, and a discoloration- or decolorization-imparting image, and
the discoloration- or decolorization-imparting image is in contact with at least part of the general image and contains a compound responsible for discoloration or decolorization, the compound having a function of discoloring or decolorizing the general image; and
a heat treatment step of holding the retransfer layer of the thermal transfer printed material at a predetermined temperature for a predetermined period of time to discolor or decolorize the general image.
